(19) United States
(12) Patent Application Publication
(10) Pub. No.: US 2026/0321681 A1
(43) Pub. Date: Oct. 15, 2026

(54) ULTRAFINE SINGLE OR MULTI-METALLIC CATALYSTS INCLUDING PLATINUM BASED CATALYSTS FOR FUEL CELL APPLICATIONS

(71) Applicant: The Regents of the University of California, Oakland, CA (US)

(72) Inventors: Yu HUANG, Los Angeles, CA (US); Xiangfeng DUAN, Los Angeles, CA (US); Zipeng ZHAO, Los Angeles, CA (US); Zeyan LIU, Los Angeles, CA (US)

(73) Assignee: The Regents of the University of California, Oakland, CA (US)

(21) Appl. No.: 18/996,758

(22) PCT Filed: Jul. 17, 2023
(86) PCT No.: PCT/US2023/070351

§ 371 Date: Jan. 17, 2025

Related U.S. Application Data
(60) Provisional application No. 63/390,230, filed on Jul. 18, 2022.

(51) Int. Cl. H01M 4/92

(52) U.S. Cl. CPC H01M 4/92

(57) ABSTRACT

Ultrafine platinum-based nanocatalysts may be used in fuel cells, such as proton exchange membrane fuel cells (PEMFCs). Such catalysts include platinum-based nanoparticles having a porous carbon overlayer and a core-shell structure, wherein each nanoparticle includes platinum and a non-platinum transition metal.

### CROSS REFERENCE TO RELATED APPLICATIONS

This application claims the benefit of priority to U.S. Provisional Patent Application No. 63/390,230 filed Jul. 18, 2023, which is hereby incorporated by reference, in its entirety for any and all purposes.

### GOVERNMENT RIGHTS

This invention was made with government support under Grant Number N00014-18-1-2155, awarded by the U.S. Navy, Office of Naval Research. The government has certain rights in the invention.

### FIELD

This technology relates to ultrafine platinum-based nanocatalysts that are protected by graphene pockets and the use of these catalysts in fuel cells, in particular proton exchange membrane fuel cells (PEMFCs).

### SUMMARY

The present technology provides platinum-based nanocatalysts for use in fuel cells, such as proton exchange membrane fuel cells (PEMFCs). In one aspect, a catalyst is provided that includes nanoparticles having a porous carbon overlayer and a core-shell structure, wherein each nanoparticle includes platinum. In some embodiments, each nanoparticle includes platinum and a non-platinum transition metal.

In some embodiments, the porous carbon overlayer is derived from carbon black, graphene, reduced graphene oxide, graphene oxide, and carbon nanotubes (CNT). In some embodiments, the porous carbon overlayer is derived from carbon black.

In some embodiments, the non-platinum transition metal is V, Cr, Mn, Fe, Co, Ni, Cu, Zn, or a mixture of any two or more thereof. In some embodiments, the non-platinum transition metal includes Co. In some embodiments, the non-platinum transition metal is derived from cobalt (II) acetylacetonate [Co(acac)₂]. In some embodiments, the non-platinum transition metal includes Ni. In some embodiments, the non-platinum transition metal precursor is derived from nickel (II) acetylacetonate [Ni(acac)₂].

In some embodiments, platinum is derived from platinum (II) acetylacetonate [Pt(acac)₂].

In some embodiments, the nanoparticles have an average size of about 2 nm to about 4 nm. In some embodiments, the nanoparticles have a mass-weighted average size of about 3 nm.

In some embodiments, the nanoparticles have a Pt:non-platinum transition metal atomic ratio of from about 80:20 to about 90:10, about 80:20 to about 95:5, about ≤100:>0, or it is about 100:0. In some embodiments, each nanoparticle has a core mainly including the non-platinum transition metal and/or a shell mainly including platinum.

In some embodiments, the catalyst has a face-centered cubic (fcc) structure.

In some embodiments, the catalyst has an electrochemical surface area (ECSA) of at least about 34 m²/g_{PGM}. In some embodiments, the catalyst has an ECSA of about 68 m²/g_{PGM}.

In some embodiments, the catalyst is used as a catalyst electrode layer in a fuel cell. In some embodiments, the fuel cell is a proton exchange membrane fuel cell (PEMFCs).

In some embodiments, the catalyst exhibits one or more of the following properties: a minimum mass activity (MA) of at least about 0.44 A/mg_{PGM}, a rated power of at least about 8 W/mg_{PGM} (when using air as the oxygen source), an end-of-life MA retention of at least about 60% after square wave accelerated durability test (ADT), and/or a potential loss of less than about <30 mV at 0.8 A/cm² over its lifetime.

In some embodiments, the catalyst exhibits one or more of the following properties: a minimum mass activity (MA) of about 1.18 A/mg_{PGM}, a rated power of about 13 W/mg_{PGM}, an end-of-life MA retention of about 70% after square wave accelerated durability test (ADT), and/or a potential loss of about 19 mV at 0.8 A/cm². In some embodiments, the rated power of about 13 W/mg_{PGM} is evaluated in a H₂/Air test. In some embodiments, the MA, the end-of life MA retention, and the potential loss are evaluated in a membrane electrode assembly (MEA) test.

In another aspect, a method is provided for preparing any one of the catalysts described herein. Such a method may include providing a mixture including a carbon support, a platinum precursor, and a non-platinum transition metal precursor, and a solvent; removing the solvent to provide a powder including the platinum precursor and the non-platinum transition metal precursor adsorbed on the carbon support; and annealing the powder to form nanoparticles that include a porous carbon overlayer.

In some embodiments, the method may include after annealing, washing the nanoparticles with acid to form washed nanoparticles, drying the washed nanoparticles to form dried nanoparticles, and annealing the dried nanoparticles. In some embodiments, wherein the annealing of the dried nanoparticles is conducted at a temperature of from about 20° C. to about 250° C. (e.g., 200° C.) for a period of about 1.5 hours to about 2.5 hours. In some embodiments, the annealing of is under H₂/Ar atmosphere. In some embodiments, the drying is conducted under vacuum. In some embodiments, the washing includes dispersing the nanoparticles with an acid solution including H₂SO₄ at a temperature of from about 80° C. to about 90° C. (e.g., 85° C.) for a period of about 12 to about 16 hours.

In some embodiments, annealing the powder to form nanoparticles is conducted at a temperature of from about 20° C. to about 700° C. for a period of about 12 to about 20 hours and then at a temperature of about 700° C. for a period of about 8 to about 16 hours. In some embodiments, the annealing is conducted under an H₂/Ar atmosphere.

In some embodiments, the removing the solvent is conducted under ambient pressure and temperature, vacuum with ambient temperature, or supercritical conditions in a supercritical dryer. In some embodiments, the solvent is acetone.

### BRIEF DESCRIPTION OF THE DRAWINGS

FIGS. 1A-1E schematics of a protective pocket design and characterization of the PtCo@Gnp. FIG. 1A is a schematic illustration of ultrafine nanocatalysts encaged in graphene pockets and its impact on ECSA retention after accelerated durability tests. Characterization of the PtCo@Gnp before catalysis test: (FIG. 1B) TEM (tunneling electron microscope) image, (FIG. 1C) size distribution, (FIG. 1D) HAADF STEM (high-angle annular dark-field scanning transmission electron microscopy) image and EDS (energy dispersive spectrometry) elemental maps, and (FIG. 1E) bright field STEM images highlighting enclosure of ultrafine nanoparticle by graphene pockets (indicated by white arrows).

FIGS. 2A-2E show the mass activity (MA) of Pt/C, c-PtCo/C, and PtCo@Gnp tested in membrane electrode assemblies (MEA) and compared to representative catalysts in the literature. FIG. 2A-2C MA test under H₂/O₂ flow at 80 C, 150 kPa_{abs} at the cathode loading of 0.060 mg_{PGM}/cm² (total loading 0.070 mg_{PGM}/cm²). Comparison of (FIG. 2A) polarization plots tested in H₂/O₂, (FIG. 2B) MA, (FIG. 2C) MA retention. FIG. 2D illustrates a comparison of beginning-of-life (BOL) and end-of-life (EOL) MA between PtCo@Gnp with the state-of-art in literature. The solid symbols highlight the materials evaluated strictly following the DOE recommended square wave accelerated durability test (ADT), which is five times more aggressive (29) than the hollow symbols represented triangle wave ADT. The plot highlights that the PtoCo@Gnp MEAs show extraordinary EOL MAs far outperforming all other reported values. “Ordered-PtCo” is abbreviated as “O—PtCo.” The star symbols represent MA performance of MEAs with different PGM loadings ((1) 0.070 and (2) 0.100 mg_{PGM}/cm²) evaluated in this study, showing considerably higher EOL MA than all previous studies and highlighting exceptional durability. Note that Ref. (31) presents catalysts with mixed PGM and non-PGM sites but only normalized by PGM material (0.033 mg_{Pt}/cm² for LP@PF-1, 0.035 mg_{Pt}/cm² for LP@PF-2). FIG. 2E is a comparison of the mass activity of tested catalysts and several representative PGM-based catalysts (with key performance surpass DOE target) reported in recent literature. The comparison includes the mass activity at the BOT, EOT, and the retention ratio, ADT cycle protocol (*Data extracted from plots). The error bars in panel (FIG. 2B) represent the standard deviation.

FIGS. 3A-3G show MEAs with ultra-low PGM loading (total loading of 0.07 mg_{PGM}/cm² include both cathode and anode) tested under H₂/Air. FIGS. 3a-3d show the polarization plots. FIG. 3A is a comparison of Pt/C and PtCo@Gnp at the beginning-of-life (BOL). FIG. 3B is a comparison of Pt/C at BOL and end-of-life (EOL). FIG. 3C is a comparison of PtCo at BOL and EOL. FIG. 3D is a comparison of PtCo@Gnp at BOL and EOL. FIG. 3E is a rated power of MEA normalized by total PGM loading. FIG. 3F is a comparison of potential loss at 0.8 A/cm² (EOL vs. BOL). The above results are an average of two MEAs. The error bars in FIGS. 3E and 3F represent the standard deviation. FIG. 3G is a comparison of the PGM loading in Toyota Mirai and the projected loading in a 90 kW FCV based on DOE target and PtCo@G.

FIGS. 4A-4I show the characterization of catalysts at EOL, analysis of size distribution, and corresponding MEA test results. TEM images of nanocatalysts at EOL, and corresponding mass-weighted size analysis of Pt/C (FIG. 4A), c-PtCo/C (FIG. 4B), and PtCo@Gnp (FIG. 4C). FIG. 4D is an STEM image and the corresponding EDS elemental map of PtCo@Gnp at EOT. FIGS. 4E and 4F are bright-field (BF) STEM images of PtCo@Gnp at EOL (the white arrow indicates the graphene pocket). FIG. 4G is a comparison of ECSA. FIG. 4H is a pressure independent oxygen transport resistance for tested MEAs, where the error bars represent standard error. FIG. 4I is an estimated nanoparticle per electrode area (particle density) for cathode catalysts.

FIGS. 5A-5C show oxygen transport resistance vs. catalyst roughness factor to highlight the impact of PGM loading on the durability of MEA. The roughness factor is defined as the electrochemical active area (APGM) divided by the area of the electrode (Ageo) and correlates with the number of catalyst nanoparticles for a given PGM loading. For high PGM loading with a larger number of catalytic sites, the oxygen diffusion resistance is relatively small. Nanocatalyst coalescence or Ostwald ripening during the ADT reduces the number of catalytic sites, and thus require delivering more O₂ to a given catalytic site and thus lead to a slight increase of oxygen transport resistance. In contrast, for the low PGM loading, more oxygen is to be delivered onto each nanocatalyst to maintain the same current, and size growth during ADT could cause a more serious challenge in oxygen diffusion, thus leading to a more dramatic increase in oxygen diffusion resistance. Additionally, similar challenges exist for water removal. At lower PGM loading, more water needs to be removed from a given catalytic site, which may also contribute to faster diffusion of dissolved Pt atoms and a more rapid Ostwald ripening process, thus further accelerating the catalyst degradation. FIG. 5A is a sketch of oxygen transport resistance related to roughness factor (related to PGM loading) during the fuel cell operation (BOL vs. EOL). FIG. 5B illustrates the voltage loss at 0.8 A/cm2 (BOL vs. EOL) at different loading. FIG. 5C is an increased ratio of measured oxygen transport resistance (BOL vs. EOL) at different loading. The original measured data is included in Table 1, FIGS. 12A-12F, and FIGS. 13A-13B.

FIGS. 6A-6I show the TEM image of the catalysts at three stages. The prepared catalysts are: Pt/C (FIG. 6A), c-PtCo/C (FIG. 6B), and PtCo@Gnp (FIG. 6C). Catalysts at the beginning of life (BOL) or beginning of test (BOT): Pt/C (FIG. 6D), c-PtCo/C (FIG. 6E), and PtCo@Gnp (FIG. 6F). Catalysts at the end-of-life (EOL) or end of test (EOT): Pt/C (FIG. 6G), c-PtCo/C (FIG. 6H), and PtCo@Gnp (FIG. 6I). Note that the as prepared catalysts are the catalysts before the MEA fabrication and test. BOL represents the stage after the activation process, initial MA test, rated power test, and ECSA test in MEA. The EOL represents the stage after ADT and all performance evaluation tests after ADT.

FIGS. 7A-7B show the characterization of tested catalysts by XRD of Pt/C, c-PtCo/C, and PtCo@Gnp (FIG. 7A), and XPS spectra of PtCo@Gnp (FIG. 7B).

FIGS. 8A-8L show the characterization of PtCo@G. FIGS. 8A, 8D, 8G, and 8J are HAADF STEM images, FIGS. 8B, 8E, 8H, and 8K are bright-field (BF) STEM images, and FIGS. 8C, 8F, 8I, and 8L are corresponding EELS map at carbon K-edge of PtCo@Gnp. FIGS. 8A-8F correspond to the same region shown in FIG. 1F. FIGS. 8G, 8H, and 8I correspond to the same region shown in FIG. 4E.

FIGS. 9A-9C show rotating disk electrode (RDE) test of catalysts, where FIG. 9A includes cyclic voltammetry curves tested in N₂ saturated 0.1 M HClO₄, FIG. 9B includes ORR polarization curves in O₂ saturated 0.1 M HClO₄, and FIG. 9C shows a comparison of mass activities (MA) and specific activities (SA).

FIGS. 10A-10C show the mass activity (MA) of PtCo@Gnp, Pt/C tested in membrane electrode assembly (MEA) at the cathode loading of 0.090 mg_{PGM}/cm² (total loading 0.100 mg_{PGM}/cm²). (FIGS. 10A-10C) MA test under H₂/O₂ flow at 80° C., 150 kPaabs. Comparison of (FIG. 10A) polarization plots tested in H₂/O₂, (FIG. 10B) MA, (FIG. 10C) MA retention.

FIGS. 11A-11C show MEA with total PGM loading of 0.100 mg_{PGM}/cm² (both cathode and anode) tested under H₂/Air. FIG. 11A is a comparison of Pt/C and PtCo@Gnp at the beginning-of-life (BOL), FIG. 11B is a comparison of Pt/C at BOL and end-of-life (EOL), and FIG. 11C is a comparison of PtCo@Gnp at BOL and EOL.

FIGS. 12A-12F show the measured total oxygen transport resistances in an MEA at BOL and EOL were plotted with the total pressure during the measurement. The total loading (anode plus cathode) is 0.070 mg_{PGM}/cm². The catalysts shown are Pt/C BOL (FIG. 12A), c-PtCo/C BOL (FIG. 12B), PtCo@Gnp BOL (FIG. 12C), Pt/C EOL (FIG. 12D), c-PtCo/C EOL (FIG. 12E), and PtCo@Gnp EOL (FIG. 12F). The total oxygen transport resistance can be separated into a pressure-dependent part (R^{P-d}) and a pressure-independent part (R^{P-ind}), which represent the Knudsen diffusion and diffusion of oxygen through the ionomer layer in the catalyst layer. Thus, the pressure-independent part is critical for oxygen transport in an operating fuel cell. The relationship of total oxygen resistance (Rₜₒₜₐₗ), pressure-dependent part of oxygen transport resistance (R^{P-d}), and pressure independent part of oxygen transport resistance (R^{P-ind}) can be expressed in the following equation: Rₜₒₜₐₗ=R^{P-d}+R^{P-ind}.

FIGS. 13A-13B show the measured total oxygen transport resistances in an MEA at BOL and EOL were plotted with the total pressure during the measurement, where the total loading (anode plus cathode) was 0.100 mg_{PGM}/cm² for Pt/C BOL (FIG. 13A), and Pt/C EOL (FIG. 13B).

FIGS. 14A-14C show size distribution of catalysts weighted by surface area at both BOL and EOL for Pt/C (FIG. 14A), c-PtCo/C (FIG. 14B), and PtCo@Gnp (FIG. 14C).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

The requirement of costly platinum group metal (PGM) catalysts represents the critical roadblock for the widespread adoption of proton exchange membrane fuel cells (PEMFCs). The ultrafine nanocatalysts with high specific surface area can promise high mass activity to reduce the PGM loading but are fundamentally less stable and may undergo serious aggregation in practical PEMFC operations.

Disclosed herein are ultrafine platinum-based nanocatalysts encaged in graphene pockets (such as ultrafine platinum cobalt nanocatalysts encaged in graphene pockets or PtCo@G). These nanocatalysts allow for highly robust ultralow PGM loading of PEMFCs. For example, the PtCo@G nanocatalysts described herein deliver a state-of-the-art mass activity of 1.18 A/mg_{PGM} in membrane electrode assembly and retain 72% of its initial activity after accelerated durability test (ADT), greatly exceeding technical targets set by the US Department of Energy (DOE) (0.44 A/mg_{PGM} initial mass activity with 60% retention after ADT). The assembled PEMFCs demonstrate a mass normalized rated power of 13.2 W/mg_{PGM}, with a projected PGM loading of only 6.8 gram for a 90-kW fuel cell vehicle, approaching the PGM loading in a typical catalytic converter.

The present technology provides platinum-based nanocatalysts for use in fuel cells, such as proton exchange membrane fuel cells (PEMFCs). Thus, provided in one aspect is a catalyst including a platinum-based nanoparticles having a porous carbon overlayer and a core-shell structure, wherein each nanoparticle includes platinum. In some embodiments, each nanoparticles includes platinum and a non-platinum transition metal.

In some embodiments, the porous carbon overlayer is derived from carbon black, graphene, reduced graphene oxide, graphene oxide, and carbon nanotubes (CNT). In some embodiments, the porous carbon overlayer is derived from carbon black.

In some embodiments, the non-platinum transition metal is V, Cr, Mn, Fe, Co, Ni, Cu, Zn, or a mixture of any two or more thereof. In some embodiments, the non-platinum transition metal includes Co. In some embodiments, the non-platinum transition metal is derived from cobalt (II) acetylacetonate [Co(acac)₂]. In some embodiments, the non-platinum transition metal includes Ni. In some embodiments, the non-platinum transition metal precursor is derived from nickel (II) acetylacetonate [Ni(acac)₂].

In some embodiments, platinum is derived from platinum (II) acetylacetonate [Pt(acac)₂].

In some embodiments, the nanoparticles have a mass-weighted average size of less than about 10 nm or less than about 5 nm. In some embodiments, the nanoparticles have a mass-weighted average size of about 2 nm to about 4 nm, including about 2 nm, about 3 nm, about 4 nm. In some embodiments, the nanoparticles have a mass-weighted average size of about 3 nm.

In some embodiments, the nanoparticles have a Pt:non-platinum transition metal atomic ratio of from about 60:40 to about 90:10 and 95:5, or 100:0, including about 60:20, about 70:30, about 80:20, and about 90:10. In some embodiments, the nanoparticles have a Pt:non-platinum transition metal atomic ratio of from about 80:20 to about 90:10, including about 80:20; about 85:15, and about 90:10. In some embodiments, each nanoparticle has a core mainly including the non-platinum transition metal and/or a shell mainly including platinum.

In some embodiments, the catalyst has a face-centered cubic (fcc) structure.

In some embodiments, the catalyst has an electrochemical surface area (ECSA) of at least about 34 m²/g_{PGM}, including about 35 m²/g_{PGM}, about 40 m²/g_{PGM}, about 45 m²/g_{PGM}, about 50 m²/g_{PGM}, about 55 m²/g_{PGM}, about 60 m²/g_{PGM}, about 65 m²/g_{PGM}, about 68 m²/g_{PGM}, about 70 m²/g_{PGM}, about 75 m²/g_{PGM}, about 80 m²/g_{PGM}, about 85 m²/g_{PGM}, about 90 m²/g_{PGM}, and about 95 m²/g_{PGM}. In some embodiments, the catalyst has an ECSA of at least about 41.5 m²/g_{PGM}. In some embodiments, the catalyst has an ECSA of about 68 m²/g_{PGM}.

In some embodiments, the catalyst is used as a catalyst electrode layer in a fuel cell. In some embodiments, the fuel cell is a proton exchange membrane fuel cell (PEMFCs).

In some embodiments, wherein the catalyst exhibits one or more of the following: (a) a minimum mass activity (MA) of at least about 0.44 A/mg_{PGM}; (b) a rated power of at least about 8 W/mg_{PGM} (when using air as the oxygen source); (c) an end-of-life MA retention of at least about 60% after square wave accelerated durability test (ADT); and (d) a potential loss of less than about <30 mV at 0.8 A/cm² (over its lifetime).

In some embodiments, wherein the catalyst exhibits a minimum mass activity (MA) of at least about 0.44 A/mg_{PGM}, including about 0.44 A/mg_{PGM}, about 0.50 A/mg_{PGM}, about 0.60 A/mg_{PGM}, about 0.70 A/mg_{PGM}, about 0.75 A/mg_{PGM}, about 0.80 A/mg_{PGM}, about 0.90 A/mg_{PGM}, about 1.00 A/mg_{PGM}, about 1.10 A/mg_{PGM}, about 1.20 A/mg_{PGM}, about 1.25 A/mg_{PGM}, about 1.30 A/mg_{PGM}, about 1.40 A/mg_{PGM}, about 1.50 A/mg_{PGM}, about 1.60 A/mg_{PGM}, about 1.70 A/mg_{PGM}, about 1.80 A/mg_{PGM}, about 1.90 A/mg_{PGM}, about 2.00 A/mg_{PGM}, about 2.50 A/mg_{PGM}, and about 3.00 A/mg_{PGM}

In some embodiments, wherein the catalyst exhibits a rated power of at least about 8 W/mg_{PGM}, including about 8 W/mg_{PGM}, about 9 W/mg_{PGM}, about 10 W/mg_{PGM}, about 11 W/mg_{PGM}, about 12 W/mg_{PGM}, about 13 W/mg_{PGM}, about 14 W/mg_{PGM}, about 15 W/mg_{PGM}, about 16 W/mg_{PGM}, about 17 W/mg_{PGM}, about 18 W/mg_{PGM}, about 19 W/mg_{PGM}, about 20 W/mg_{PGM}, and about 25 W/mg_{PGM}, (when using air as the oxygen source).

In some embodiments, wherein the catalyst exhibits an end-of-life MA retention of at least about 60%, including about 60%, about 65%, about 70%, about 75%, about 80%, about 85%, about 90%, and about 95%, after square wave accelerated durability test (ADT).

In some embodiments, wherein the catalyst exhibits a potential loss of less than about <30 mV, including about 5 mV, about 10 mV, about 11 mV, about 12 mV, about 13 mV, about 14 mV, about 15 mV, about 16 mV, about 17 mV, about 18 mV, about 19 mV, about 20 mV, about 25 mV, and about 29 mV, at 0.8 A/cm² (over its lifetime).

In some embodiments, wherein the catalyst exhibits one or more of the following: (a) minimum mass activity (MA) of about 1.18 A/mg_{PGM}; (b) a rated power of about 13 W/mg_{PGM}; (c) an end-of-life MA retention of about 70% after square wave accelerated durability test (ADT); and (d) a potential loss of about 19 mV at 0.8 A/cm².

In some embodiments, wherein the catalyst exhibits one or more of the following: (a) minimum mass activity (MA) of about 1.21 A/mg_{PGM}; (b) a rated power of about 13 W/mg_{PGM}; (c) an end-of-life MA retention of about 70% after square wave accelerated durability test (ADT); and (d) a potential loss of about 19 mV at 0.8 A/cm². In some embodiments, (b) is evaluated in a H₂/Air test. In some embodiments, (a), (c), and (d) are evaluated in a membrane electrode assembly (MEA) test.

Also provided in another aspect is method for preparing any one of the catalysts described herein, including: (a) providing a mixture including a carbon support, a platinum precursor, and a non-platinum transition metal precursor, and a solvent; (b) removing the solvent to provide a powder including the platinum precursor and the non-platinum transition metal precursor adsorbed on the carbon support; and (c) annealing the powder to form platinum-based nanoparticles including a porous carbon overlayer.

In some embodiments, the method further including, after step (c): (d) washing the platinum-based nanoparticles with acid; (e) drying the platinum-based nanoparticles; and (f) annealing platinum-based nanoparticles.

In some embodiments, wherein the annealing of step (f) is at a temperature of from about 20° C. to about 250° C., including from about 100° C. to about 250° C., from about 150° C. to about 250° C., and from about 175° C. to about 225° C., for a period of about 1.5 hours to about 2.5 hours. In some embodiments, wherein the annealing of step (f) is at a temperature of about 200° C. for a period of about 1.5 hours to about 2.5 hours. In some embodiments, the annealing of step (f) is under H₂/Ar atmosphere.

In some embodiments, the drying of step (e) is with vacuum drying.

In some embodiments, the washing of step (d) includes dispersing the platinum-based nanoparticles with an acid solution including H₂SO₄ at a temperature of from about 80° C. to about 90° C., including about 80° C., about 85° C., and about 90° C., for a period of about 12 to about 16 hours. In some embodiments, the washing of step (d) includes dispersing the platinum-based nanoparticles with an acid solution including H₂SO₄ at a temperature of about 85° C. for a period of about 12 to about 16 hours.

In some embodiments, the annealing of step (c) is at a temperature of from about 20° C. to about 700° C. for a period of about 12 to about 20 hours and then at a temperature of about 700° C. for a period of about 8 to about 16 hours. In some embodiments, the annealing of step (c) is under H₂/Ar atmosphere.

In some embodiments, the removing of step (b) is under ambient pressure and temperature, vacuum with ambient temperature, or supercritical condition at a supercritical dryer.

In some embodiments, the solvent is acetone.

The present invention, thus generally described, will be understood more readily by reference to the following examples, which are provided by way of illustration and are not intended to be limiting of the present invention.

### EXAMPLES

Proton exchange membrane fuel cells (PEMFCs) are of immense interest as a zero-emission power source to replace the internal combustion engine. Platinum (Pt) group metals (PGMs) are typically used as catalysts in commercial PEMFCs, especially as the cathode catalysts for accelerating the sluggish oxygen reduction reaction (ORR) (1). The high cost and limited reserve of PGMs have seriously limited the broad implementation of PEMFCs (2). We note that the current internal combustion engine also requires PGM catalysts in catalytic converters to reduce hazardous gas emission (~2-8 gram per vehicle) (3), which contributes to nearly half of the total global demand (4, 5). The amount of PGMs used in a current commercial fuel cell vehicle (FCV) is about 5-10 times higher (e.g., ~36 gram per vehicle in Toyota Mirai) (6-8), which is clearly not sustainable. Hence, the high cost and limited reserve of PGM represent the most critical roadblock to the broad implementation of PEMFCs (2).

To enable more widespread adoption of PEMFCs, it is highly desirable to reduce the PGM usage to the level of the internal combustion engine powered vehicles (9), which has motivated worldwide efforts to develop more active and durable catalysts that can dramatically reduce PGM usage. To this end, the US Department of Energy (DOE) has set a series of technical targets for PEMFC catalysts, including a minimum beginning-of-life (BOL) mass activity (MA) of 0.44 A/mg_{PGM}, a rated power of 8 W/mg_{PGM} when using air as the oxygen source, an end-of-life (EOL) MA retention of 60% after square wave accelerated durability test (ADT) and a potential loss <30 mV at 0.8 A/cm² after the aggressive square wave accelerated durability test (ADT) (10).

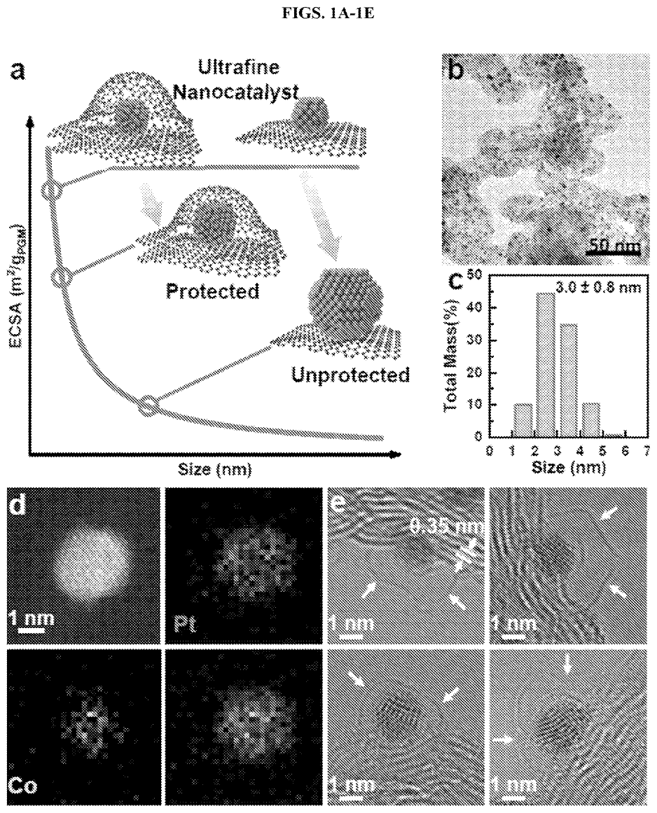

Simultaneously achieving these technical targets in practical fuel cells (the DOE targets in practical PEMFCs at the ultralow PGM loading) has been difficult due to several intrinsically trade-off challenges. In general, the intrinsic MA of a given PGM catalyst is fundamentally determined by the product of its specific activity (SA) and electrochemical surface area (ECSA). Although an increase of either SA or ECSA could lead to a significant boost of the intrinsic MA (as demonstrated in many fundamental studies with a rotation disc electrode (RDE) measurements) (11-16), such improved MA may not readily translated to a proportional reduction of PGM loading in practical PEMFCs, where mass transport plays a more important role, without compromising the performance (9, 17). In this regard, although advanced PGM catalyst with high SA can in principle help maintain the activity by providing higher turnover frequency (TOF), it exerts higher stress on mass transport in order to deliver more reactants to and remove more products away from each catalyst site. Particularly, a reduction in PGM loading reduces the total number of active sites on the electrode, elevating mass transport stress to each active site and eventually causing serious mass transport resistance that limit the achievable power or MA in practical PEMFCs (18). Alternatively, a reduction of the catalyst size to form ultrafine nanocatalysts can lead to higher ECSA (larger number of available sites per mass) and higher MA (FIG. 1A) and mitigate the mass transport limitations at the reduced PGM loading. However, the high surface-to-volume ratio of such ultrafine nanoparticles (particularly for those <4 nm) is thermodynamically less stable and prone to substantial size growth through either a physical aggregation or Oswald ripening process (19, 20), gradually losing ECSA and MA and leading to unsatisfactory durability. Simultaneous achievement of high ECSA and high durability has been a persistent challenge for nanocatalysts.

Therefore, the desired reduction of the PGM loading in MEA to the ultralow level exacerbates the challenge of retaining long-term operation durability. In particular, to sustain the same power density (or current density) at a lower PGM loading means a higher TOF on a given catalytic site, necessitating faster oxygen delivery and water removal, which could accelerate the diffusion of dissolved Pt atoms and the Ostwald ripening process, thus further aggravating the catalyst degradation during PEMFC operation. Additionally, considering that the oxygen transport resistance in the MEA is inversely proportional to the number of catalytic sites (9, 51), at ultralow PGM loading with already reduced active sites to possibly just above the function threshold, a slight catalyst degradation (e.g., catalyst coalescence and reduction of catalytic sites after ADT) could lead to a more dramatic increase of oxygen transport resistance and consequently a more substantial performance loss, much more severe than that in MEA with higher PGM loading (FIGS. 5A-5C) (9). For example, the durability of the MEA cells made with commercial Pt/C catalyst, severely degraded when the total PGM loading is reduced from 0.100 to 0.070 mg/cm², with the voltage loss at 0.80 mA/cm² increased substantially from 54 mV to 163 mV after ADT, far exceeding the DOE target of 30 mV (FIGS. 5A-5C). Thus, to maintain the long-term stability in PEMFCs with ultralow PGM loading represents a highly demanding situation that requires ultrafine sized nanocatalysts with exceptional durability, two intrinsically competing requirements in a nanocatalyst design. This has imposed a persistent challenge to continue reducing the PGM loading in practical PEMFCs to reach the level of ICE vehicles.

### Platinum Cobalt Nanocatalysts

Here we report the design and synthesis of ultrafine platinum cobalt nanocatalysts encaged in graphene pockets (PtCo@G or PtCo@Gnp) that can retain high ECSA in long-term operation to enable highly robust ultralow PGM loading fuel cells (e.g., PEMFCs, FIG. 1A). With this design, the ultrafine size is essential for ensuring sufficient total ECSA at the reduced PGM loading to alleviate the mass transport limitation, while the encaging by the graphene pockets can effectively prevent the physical movement and aggregation, as well as slow down the oxidative dissolution, diffusion and Oswald ripening of the ultrafine nanoparticles, thus retaining the ultrafine size with high ECSA to result in superior durability. Additionally, the protective graphene pockets can also help separate the PGM active sites from the ionomer, mitigating the ionomer poisoning effect to further improve the activity and stability of the catalytic sites (17). With this elaborated design, we show the ultrafine PtCo@Gnp nanocatalysts deliver a state-of-the-art MA of 1.18 A/mg_{PGM}, rated power of 13.2 W/mg_{PGM} in H₂/Air test, a MA retention of 72% and a potential loss of only 19.0 mV at 0.8 A/cm² in membrane electrode assembly (MEA) test, all exceeding the DOE technical targets. Importantly, our catalysts enabled a fuel cell to operate at ultra-low PGM loading (0.07 mg_{PGM}/cm² including both cathode and anode), which is much lower than the DOE target (0.125 mg_{PGM}/cm²) and close to the DOE stretch target (0.0625 mg_{PGM}/cm²) projected for wide-spread adoption of PEMFCs (to balance the market demand and limited PGM reserve) (9). With greatly improved rated power (13.2 W/mg_{PGM}), MA, durability in MEAs with an ultralow PGM loading (0.070 mg/cm²) in our PtCo@G nanocatalyst, we project a 90-kW fuel cell vehicle (FCV) can be realized with an ultralow PGM loading of only 6.8 grams, comparable to the PGM loading in the typical catalytic converters for internal combustion engine (ICE) powered vehicles (~2-8 gram per vehicle) (3, 9).

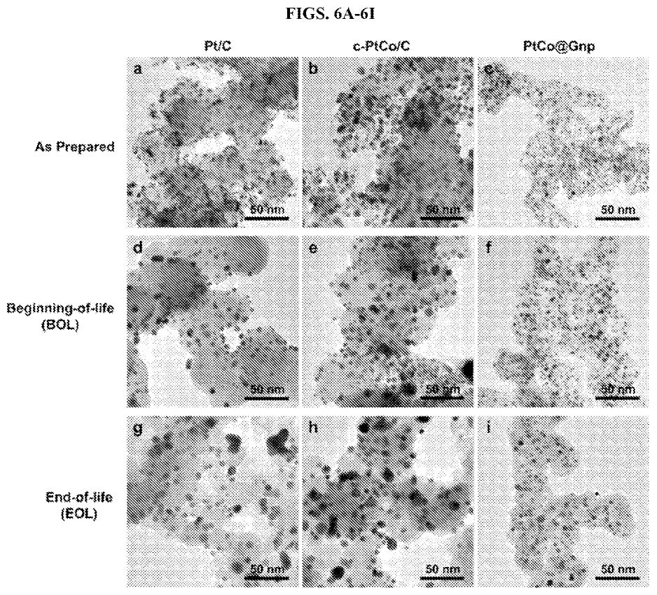

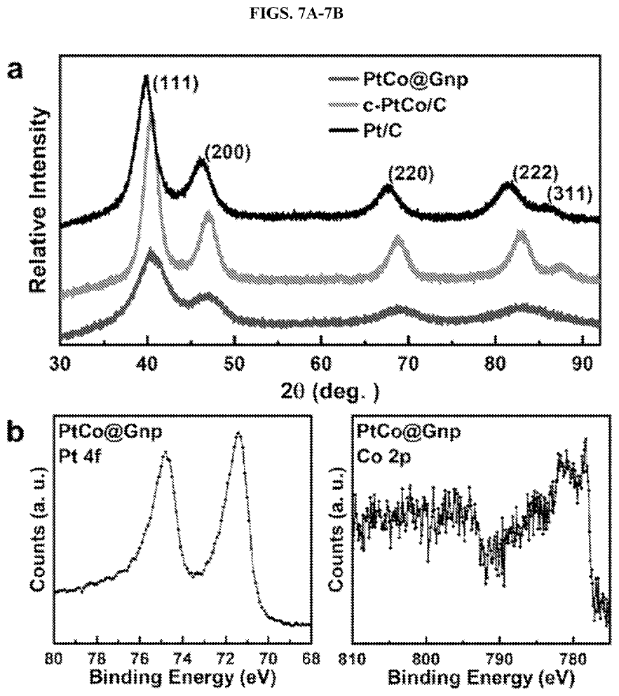

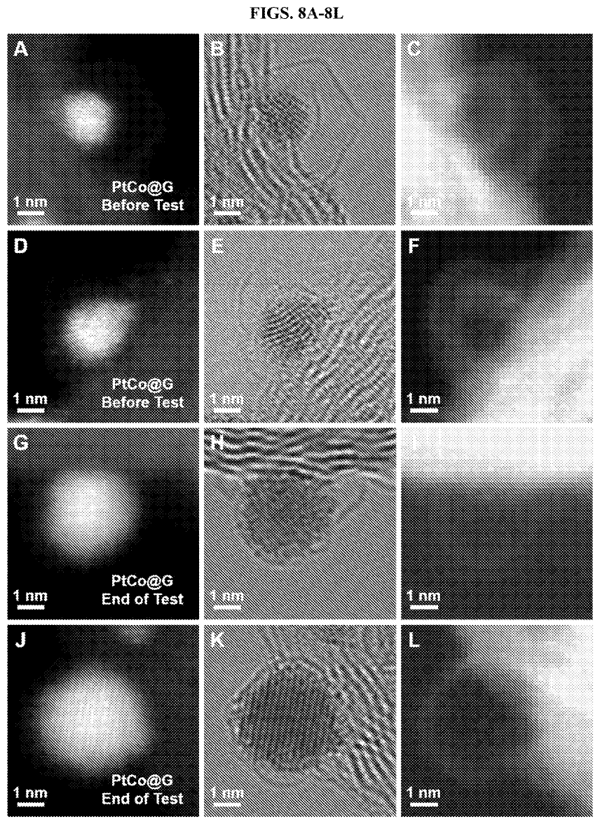

The PtCo@G nanocatalysts were prepared by impregnating carbon support with organometallic Pt and Co precursors [platinum acetylacetonate: Pt(acac)₂; and cobalt acetylacetonate: Co(acac)₂] in acetone solution. The metal precursors were loaded on the carbon support by evaporating the acetone solvent in a vacuum, which were then subjected to a high-temperature pyrolysis process at 700° C. under the flow of mixed argon and hydrogen. The prepared catalysts were further washed with sulfuric acid to pre-leach the Co content (21), in order to alleviate the poisoning of the ionomer by the Co cations (22, 23). The transmission electron microscopy (TEM) studies reveal ultrafine nanoparticles uniformly distributed on the carbon support with a mass-weighted average size of 3.0±0.8 nm (FIGS. 1B, 1C, 56-6I, Table 2). The powder X-ray diffraction (XRD) studies show the resulted catalysts exhibit a face-centered cubic (fcc) structure, same as Pt/C (FIG. 7A). The broadening in XRD peaks gives an average grain size of 2.1 nm, which is consistent with the TEM measurements (Table S1). The overall composition analysis by the inductively coupled plasma atomic emission spectroscopy (ICP-AES) of the PtCo@Gnp nanocatalysts gives a Pt: Co atomic ratio of 80.8:19.2, while the surface-sensitive X-ray photoelectron spectroscopy (XPS) reveals a higher Pt: Co ratio of 89.4:10.6 (FIG. 7B), indicating a core-shell structure with a Pt-rich shell, which is also confirmed by scanning transmission electron microscope (STEM) and the corresponding energy-dispersive X-ray spectroscopy (EDS) elemental mapping (FIG. 1C).

We have further used high-resolution STEM studies to examine the detailed microscopic structure of the resulting PtCo nanocatalysts. A close comparison of the high-angle annular dark field (HAADF) and bright field STEM images reveals that the ultrafine PtCo nanoparticles are encaged in nanoscale pockets consisting of monolayer or few-layer graphene enclosures (FIG. 1E, FIGS. 8A-8L). In particular, the bright-field STEM image clearly shows that the PtCo nanoparticles are well supported on carbon backbone structure, in which the graphitic layers are well resolved. Notably, an additional graphitic layer (typically monolayer graphene) is clearly visible surrounding the PtCo nanoparticles. An exhaustive examination of the PtCo nanoparticles shows all of them are caged in similar graphene pockets (FIG. 1E). The presence of the graphene outer layer over the PtCo nanoparticles was also confirmed by electron energy loss spectroscopy (EELS) mapping studies (FIGS. 8A-8L). The formation of the graphitic layer may be attributed to the pyrolysis of the organic ligands (24) in organometallic precursors [Pt(acac)₂, Co(acac)₂]. During the high-temperature pyrolysis process, where the decomposition of the metal acetylacetonates generates gaseous carbonaceous molecules. (52, 53), which then react on the PtCo nanocatalyst surface leading to the in-situ formation of graphene nanopocket (54-56).

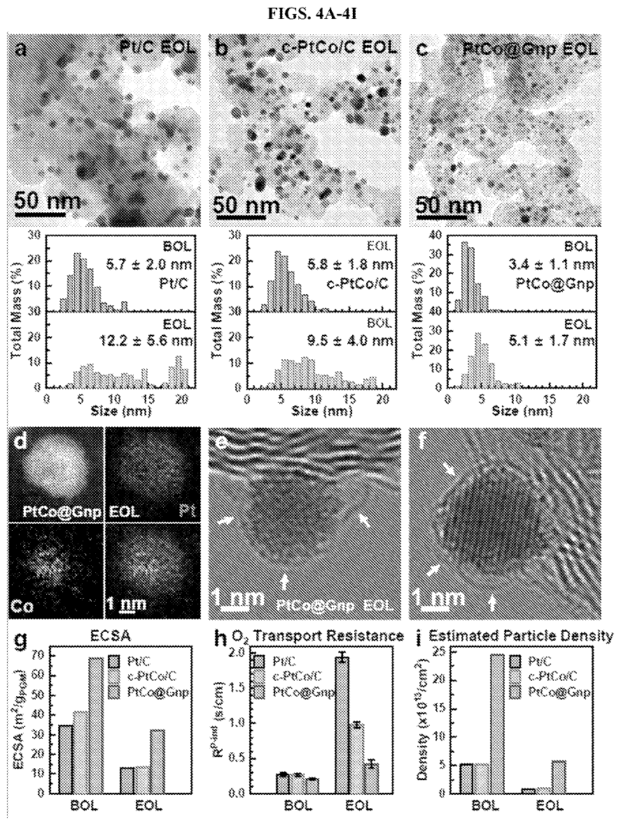

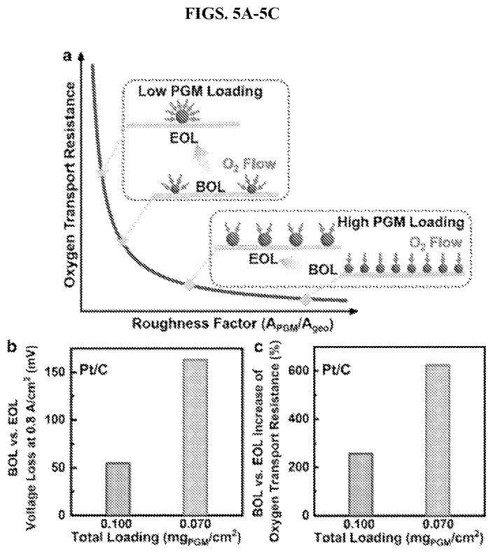

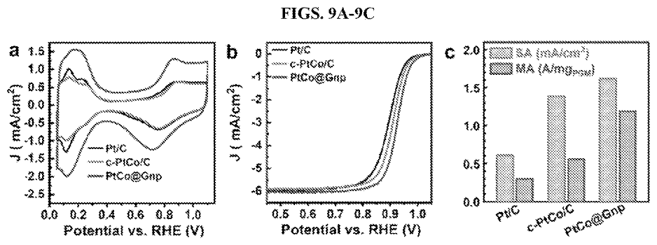

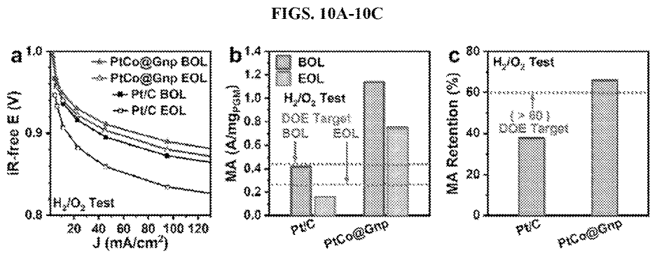

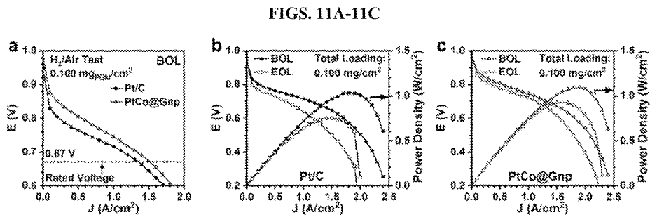

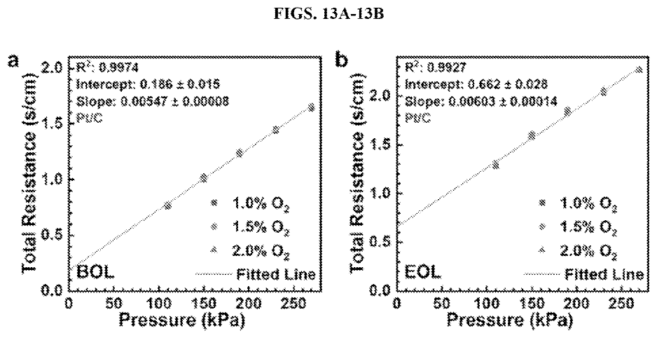

It is also noted that such graphene pockets generally do not directly encapsulate the PtCo nanoparticles, instead forming a non-contact enclosure in graphene nanopockets that renders PtCo@Gnp electrochemically accessible, featuring a nanometer-scale space (0.4-1.0 nm) in between. As we will show below, such non-contact encagement in graphene pockets plays a critical role in improving the durability of the ultrafine PtCo nanoparticles while ensuring electrochemical accessibility. In particular, our electrochemical test of PtCo@G nanocatalyst showed an impressive ECSA of 68.7 m²/g_{PGM}, which is considerably higher than that Pt/C (34.7 m²/g_{PGM}) and largely consistent with the expected ECSA based on the particle size (Table S2, S3). Similarly, the ORR specific activity of PtCo@Gnp (1.62 mA/cm²) is 2.7 times that of Pt/C (0.61 mA/cm²) measured using a rotating disk electrode (RDE) (FIGS. 9A-9C). The above features clearly indicate that the graphene nanopocket may be porous allowing for surface accessibility, and the PtCo@Gnp is electrochemically active. Although ultrafine Pt-based nanoparticles have also been explored for ORR previously, such ultrafine nanoparticles typically show rather poor stability and rapidly lose their electrochemical activity due to serious coalescence (25, 26). In contrast, the PtCo nanoparticles encaged graphene pockets show unprecedented stability against coalescence during the accelerated durability test (ADT) (see FIGS. 4A-41), and thus for the first time delivering superior performance that greatly exceeds the DOE targets in all performance metrics, including MA, rated power and long-term durability.

To study the performance of the PtCo@G nanocatalysts in a fuel cell, the membrane electrode assembly (MEA) was prepared by coating the catalysts directly on the proton exchange membrane using an ultrasonic spray system. The catalyst coated membrane (CCM), gas diffusion layer (GDL), and gasket were assembled in a fuel cell fixture. In order to benchmark against the DOE 2020 performance targets (10) and also to evaluate the performance of the PtCo@Gnp at ultralow loading, we prepared the cathodes with two distinct PGM loadings of 0.090 and 0.060 mg_{PGM}/cm². Together with the anode loading of 0.010 mg_{PGM}/cm² (commercial Pt/C), the total PGM loading is 0.100 and 0.070 mg_{PGM}/cm², respectively. We note the PGM loading of 0.070 mg_{PGM}/cm² is only 19% of the PGM loading in Toyota Mirai (0.365 mg_{PGM}/cm²) (6, 27) and represents an ultralow PGM loading approaching the DOE stretch target (0.0625 mg_{PGM}/cm²) (9). We have benchmarked our catalysts vs. Pt/C and commercial PtCo/C catalyst (noted as c-PtCo/C) at the same PGM loadings. For a fair comparison, all materials were the same in all MEAs except for the cathode catalyst. Thus, the MEAs were labeled by the cathode catalysts. All performance metrics in MEA, including ORR mass activity (MA), rated power, and durability, are tested and evaluated following the DOE recommended protocols (28).

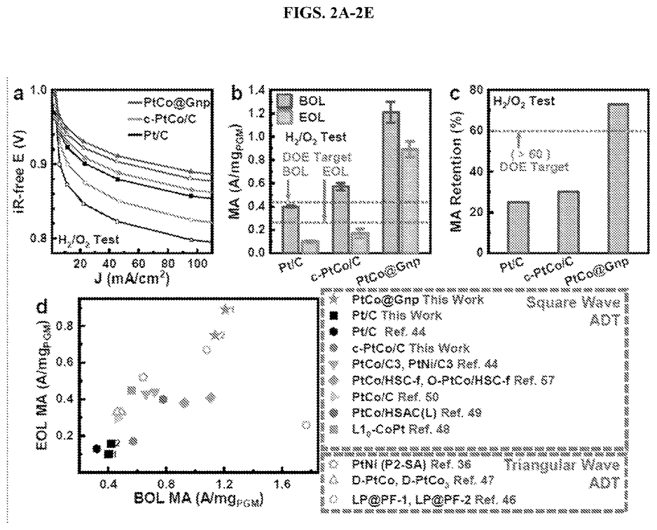

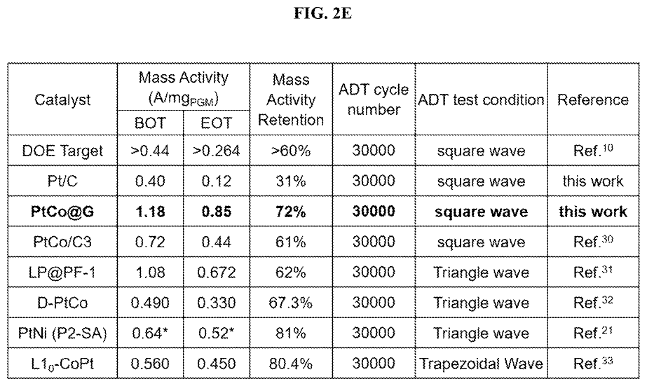

The PtCo@Gnp exhibited an initial MAs of 1.14 A/mg_{PGM} at the cathode PGM loading of 0.090 (FIGS. 10A-10C) and MA of 1.21 A/mg_{PGM} at 0.060 mg_{PGM}/cm² (FIGS. 2A-2E), considerably higher than the Pt/C (0.42 and 0.40 A/mg_{PGM}), c-PtCo (0.57 A/mg_{PGM}) and the DOE target (0.44 A/mg_{PGM}). For the ADT stability test, we adopted the updated 30,000-cycle square wave protocol for ADT, which included 30,000 cycles, and the cathode was held at 0.6 V for 3 s and 0.95 V for 3 s in each cycle (see Methods). Importantly, even at the ultralow loading of 0.070 mg_{PGM}/cm², the PtCo@Gnp retained 73% of its initial MA after the aggressive square wave ADT, which is much higher than the 25% and 30% MA retention observed in Pt/C and c-PtCo/C, respectively, at the same loading, and represents the best-known durability under the demanding ultralow PGM loading level achieved in the square wave ADT (FIG. 2D). Moreover, we note that the PtCo@Gnp EOL MA (0.89 A/mg_{PGM}) is >3 times of the DOE target (0.264 A/mg_{PGM}), >5 times of the c-PtCo/C (0.17 A/mg_{PGM}) and nearly 9 times of the Pt/C (0.10 A/mg_{PGM}) (Table 1), representing the highest EOL MA reported in MEA tests to date (FIG. 2D) (21, 30-33, 57-58). Note that the newly suggested square wave protocol shows five times acceleration factor over the previous triangle wave protocol and represents a more aggressive test protocol to better simulate the lifetime degradation of catalysts within the limited time of ADT (29). Significantly, the PtCo@G MEAs retained 72% of its initial MA (DOE target: 60% retention) at the end of test (EOT) after ADT, and demonstrated an EOT MA of 0.85 A/mg_{PGM}, which is 3.2 times of the DOE target (0.264 A/mg_{PGM}) (FIGS. 2A-2E) and represents the highest EOT MA ever reported in MEA tests to date, particularly under the more aggressive square wave ADT test (FIG. 2E) (21, 30-33).

Table 1, below, is a comparison of key performance metrics for PtCo@Gnp MEAs vs. the state-of-art in literature. At the PGM loading of 0.100 mg_{PGM}/cm², the PtCo@Gnp MEAs represent the only system that exceeds all DOE performance metrics at the recommended loading. In particular, the PtCo@Gnp MEAs exhibit extraordinary durability under the more aggressive square wave durability test. Even at the ultralow PGM loading of 0.070 mg_{PGM}/cm, the PtCo@ Gnp MEAs deliver an overall performance outperforming all DOE targets except the beginning-of-life (BOL) areal power, yet with an end-of-life (EOL) areal rated power substantially higher than those of Pt/C or c-PtCo/C at all the same or even higher PGM loadings, highlighting its extraordinary durability. The retainment of higher EOL areal power even at lower PGM loading defines the foundation for further reducing PGM without compromising the overall power output.

TABLE 1

| | | | | | | | Rated | | | Rated | | |
|---|---|---|---|---|---|---|---|---|---|---|---|---|
| | | | | | | | Power | | | Power | | |
| | | | Mass | | | | Normalized | | Potential | Normalized | | |
| | Cathode | Total | Activity | | MA | | by Mass | | Loss | by | | |
| | Loading | Loading | (MA) | | Re- | | (k^{W}rated/ | | at 0.8 | Area | | Ref- |
| | (mgPGM/ | (mgPGM/ | (A/mgPt) | | tention | ADT | gPGM) | | A/cm² | (W/cm²) | | er- |
| Catalyst | cm²) | cm²) | BOL | EOL | (%) | Condition | BOL | EOL | (mV) | BOL | EOL | ence |
| DOE 2020 | NA | ≤0.125 | >0.44 | >0.264 | >60 | Square | >8 | NA | <30 | >1 | NA | Ref. |
| Target | | | | | | Wave | | | | | | 10 |
| Pt/C | 0.090 | 0.100 | 0.42 | 0.16 | 38 | Square | 9.1 | 5.7 | 54.4 | 0.91 | 0.57 | This |
| | | | | | | Wave | | | | | | Work |
| Pt/C | 0.060 | 0.070 | 0.40 | 0.10 | 25 | Square | 11.3 | 3.8 | 163.0 | 0.79 | 0.27 | This |
| | | | | | | Wave | | | | | | Work |
| PtCo@Gnp | 0.090 | 0.100 | 1.14 | 0.75 | 66 | Square | 10.1 | 8.7 | 23.5 | 1.01 | 0.87 | This |
| | | | | | | Wave | | | | | | Work |
| PtCo@Gnp | 0.060 | 0.070 | 1.21 | 0.89 | 73 | Square | 13.2 | 11.4 | 18.8 | 0.92 | 0.80 | This |
| | | | | | | Wave | | | | | | Work |
| c-PtCo/C | 0.060 | 0.070 | 0.57 | 0.17 | 30 | Square | 12.1 | 6.5 | 100.8 | 0.85 | 0.52 | This |
| | | | | | | Wave | | | | | | Work |
| PtCo/ | 0.06 | 0.075 | 1.108 | 0.41 | 37 | Square | 14.6 | NA | 179 | 1.1 | NA | Ref. |
| HSC-f | | | | | | Wave | | | | | | 63 |
| Ordered | 0.06 | 0.075 | 0.924 | 0.38 | 41 | Square | 14 | NA | 179 | 1.05 | NA | Ref. |
| PtCo/ | | | | | | Wave | | | | | | 63 |
| HSC-f | | | | | | | | | | | | |
| PtCo/ | 0.063 | 0.088 | 0.36 | NA | NA | NA | 14.3 | NA | NA | 1.26 | NA | Ref. |
| HSC-f | | | | | | | | | | | | 3 |
| PtCo/ | 0.10 | 0.125 | 0.3 | NA | NA | NA | 9.6* | NA | NA | 1.2 | NA | Ref. |
| HSC-e | | | | | | | | | | | | 3 |
| PtCo/C3 | 0.10 | 0.15 | 0.72 | 0.44 | 61 | Square | 7.7 | NA | 16.9 | 1.16 | NA | Ref. |
| | | | | | | Wave | | | | | | 30 |
| PtNi/C3 | 0.10 | 0.15 | 0.66 | 0.43 | 65 | Square | 8.1 | NA | 16.2 | 1.21 | NA | Ref. |
| | | | | | | Wave | | | | | | 30 |
| LP@PF-1 | 0.033 | 0.383 | 1.08 | 0.67 | 62 | Triangular | NA | NA | NA | NA | NA | Ref. |
| | | | | | | Wave | | | | | | 31 |
| LP@PF-2 | 0.035 | 0.385 | 1.77 | 0.26 | 15 | Triangular | NA | NA | NA | NA | NA | Ref. |
| | | | | | | Wave | | | | | | 31 |
| PtCo/C | 0.10 | 0.5 | 0.464 | 0.296 | 63.8 | Square | NA | NA | NA | NA | NA | Ref. |
| | | | | | | Wave | | | | | | 58 |
| PtCo/ | 0.10 | NA | 0.78* | 0.40* | 51 | Square | NA | NA | NA | NA | NA | Ref. |
| HSAC(L) | | | | | | Wave | | | | | | 57 |
| L1₀-CoPt | 0.105 | NA | 0.56 | 0.45 | 80.4 | Square | NA | NA | NA | NA | NA | Ref. |
| | | | | | | Wave | | | | | | 33 |
| PtNi | 0.1 | 0.15 | 0.64* | 0.52* | 81 | Triangular | NA | NA | NA | NA | NA | Ref. |
| (P2-SA) | | | | | | Wave | | | | | | 21 |
| D-PtCo | 0.2 | 0.25 | 0.49 | 0.33 | 67.3 | Triangular | NA | NA | NA | NA | NA | Ref. |
| | | | | | | Wave | | | | | | 32 |
| D-PtCo₃ | 0.2 | 0.25 | 0.46 | 0.33 | 71.7 | Triangular | NA | NA | NA | NA | NA | Ref. |
| | | | | | | Wave | | | | | | 32 |

*Data extracted from plots. NA: not available

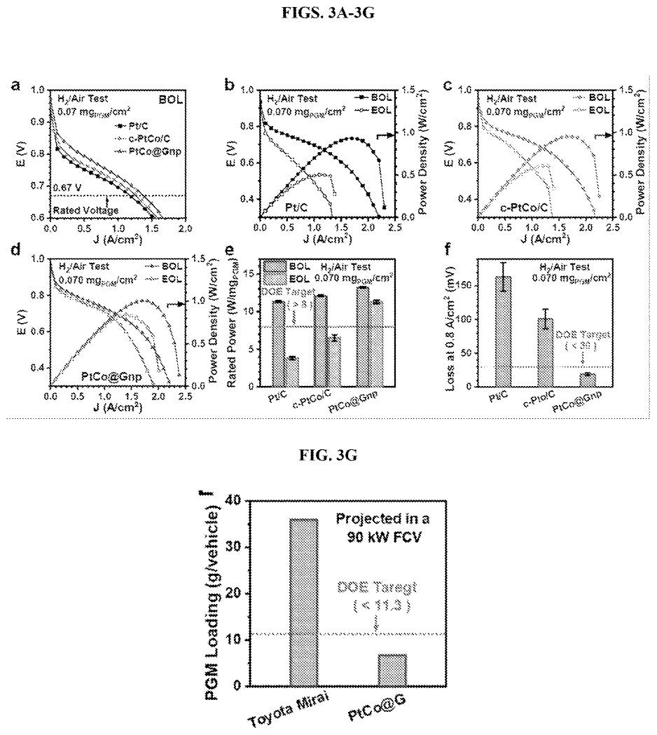

To further evaluate the performance of these MEAs in a practical fuel cell working environment, we used air as the oxygen source. While the cathode MA test under pure oxygen gives a better evaluation of the intrinsic activity less impacted by mass transfer issues, the rated power test using air as the oxygen source directly reflects the practical performance of the PEMFC under working environment. Following the recommended DOE testing protocols, the rated power of the MEAs was evaluated at 0.67 V when the fuel cell operates at 94° C. (see Methods) (3, 10, 28). In general, the PtCo@Gnp demonstrated notably better performance than Pt/C or c-PtCo/C throughout the low to high current density regime (FIG. 3A). In particular, the PtCo@Gnp delivers a mass normalized rated power of 10.1 and 13.2 W/mg_{PGM} at the PGM loading of 0.100 (FIGS. 11A-11C), and 0.070 mg_{PGM}/cm² (FIG. 3D), respectively, both of which greatly exceed the DOE target (8 W/mg_{PGM}) (FIG. 3E).

Impressively, the PtCo@Gnp exhibited outstanding durability far outperforming Pt/C or c-PtCo/C (Table 1), as reflected in EOL rated power performance after the ADT. In particular, at the ultralow PGM loading of 0.070 mg_{PGM}/cm², the PtCo@Gnp exhibited an EOL rated power of 11.4 W/mg_{PGM}, greatly exceeding that of Pt/C (3.8 W/mg_{PGM}) (FIG. 3E, Table 1). Likewise, the PtCo@Gnp showed a voltage loss as small as 18.8 mV at 0.8 A/cm² (meeting the loss <30 mV DOE target) (10) even at the ultralow PGM loading of 0.070 mg_{PGM}/cm², which is nearly one order of magnitude smaller than that of Pt/C (163 mV) or c-PtCo/C (100.8 mV) at the same loading (FIG. 3F, Table 1), clearly highlighting the greatly improved stability of the PtCo@Gnp. With such high rated power, we can project that the total Pt loading needed for a typical 90-kW fuel cell passenger vehicle is only 6.8 g PGM catalyst (9), which is only ~19% of the PGM used in a Toyota Mirai (6), significantly lower than the DOE target (11.3 g/vehicle)(9), and nearly comparable to the level of PGM loading (2-8 g) used in internal combustion engine powered vehicles (3) (FIG. 3G).

We further note that area-normalized rated power represents another critical parameter for practical applications. At the PGM loading of 0.100 mg_{PGM}/cm², the PtCo@Gnp delivers a rated power of 1.01 W/cm², satisfying the DOE target (1.0 W/cm²) and outperforming Pt/C (0.91 W/cm²). The exceptional durability of the PtCo@Gnp is particularly highlighted by the extraordinary EOL areal rated power. After the ADT, the PtCo@Gnp retained an EOL rated power of 0.87 W/cm² at the PGM loading of 0.100 mg_{PGM}/cm², greatly outperforming Pt/C (0.57 W/cm²). Furthermore, at the ultralow PGM loading of 0.070 mg_{PGM}/cm², the PtCo@Gnp MEA exhibits a phenomenal EOL areal rated power of 0.80 W/cm², far exceeding that of Pt/C (0.27 W/cm²) or c-PtCo/C (0.52 W/cm²) at the same loading (Table 1), demonstrating the extraordinary durability of the PtCo@ Gnp even under the much more demanding ultralow PGM loading conditions. To the best of our knowledge, the PtCo@Gnp represents the only catalyst that can work at the highly demanding ultralow loading conditions with all the EOL performance metrics exceeding the DOE targets (Table 1) (3, 34). Such greatly improved EOL performance can deliver more uniform power output over the lifetime, desirable for practical applications. Moreover, the greatly improved durability beyond the DOE targets could significantly prolong the fuel cell lifetime by ~50% based on linear extrapolation of MA degradation or voltage loss (59).

TABLE 2
Rated power reported in representative literature.
Measurements are performed at 250 kPa_{abs}, 94° C.

| | Rated Power | | Total PGM | Loss in | |
|---|---|---|---|---|---|
| | (W/mg_{PGM}) | | Loading | Voltage | |
| Catalyst | BOT | EOT | (mg/cm²) | at 0.8 A/cm² | Reference |
| DOE Target | >8.0 | | ≤0.125 | <30.0 | Ref. 1, 10 |
| Pt/C | 11.3 | 3.8 | 0.07 | 163.0 | This Work |
| PtCo@G | 13.2 | 11.3 | 0.07 | 19.0 | This Work |
| PtCo/HSC-f | 14.3 | NA | 0.088 | NA | Ref. 18 |
| PtCo/HSC-e | 9.6* | NA | 0.125 | NA | Ref. 18 |
| PtNi/C3 | 8.1 | 7.0 | 0.15 | 16.2 | Ref. 4 |

*Data extracted from plots.
NA: not available

We have further evaluated the EOT rated power performance after ADT. Importantly, the PtCo@G exhibited outstanding stability with a rated power of 11.3 W/mg_{PGM} at EOT, which greatly exceeded that of commercial Pt/C (4.2 W/mg_{PGM}) (FIG. 3E, Table 2). The stability of PtCo@G can also be reflected in the voltage loss at a given current density (0.8 A/cm² as suggested by DOE) from the BOT to EOT. Compared to the 163.0 mV loss in Pt/C, only 19.0 mV loss is observed in MEA with PtCo@G (FIG. 3F, Table 2), which greatly surpasses the DOE target (<30 mV). It is worth noting that the potential loss in PtCo@G (19.0 mV) is nearly one order of magnitude smaller than that in Pt/C, clearly highlighting that the significantly improved stability of PtCo@G. Together, our graphene encaged ultrafine PtCo nanocatalyst represents the only catalyst that can work at ultra-low loading conditions while meeting all DOE performance targets, especially in terms of stability (Table 2) (3, 34).

To understand the substantially different stability between PtCo@Gnp and Pt/C, we further characterized and compared the two different catalysts after the ADT in MEA. We have first evaluated the nanoparticle size distribution change before and after ADT. To reflect the mass fraction of different-sized particles, we have plotted mass-weighted size distribution before and after ADT. Overall, the mass-weighted size of Pt/C increases dramatically from 5.7±2.0 nm at BOT to 12.2±5.6 nm at EOT (FIG. 4A, Table S1). Such an increase in particles can be largely attributed to: (1) nanoparticle detachment, movement, and coalescence, and (2) oxidative dissolution, diffusion, and Oswald ripening process (20). To this end, the graphene encagement can effectively prevent nanoparticle movement and coalescence and greatly slow down the oxidative dissolution and diffusion by largely retaining the dissolved Pt atoms within the graphene pockets, which may redeposit onto the PtCo nanoparticles thus help maintain the size of the ultrafine PtCo nanoparticles. Indeed, the mass-weighted average size of the PtCo@Gnp only increased moderately from 3.4±1.1 nm at BOT to 5.1±1.7 nm at EOT (FIG. 4C), clearly highlighting that the presence of graphene pockets has effectively restrained further growth of the PtCo nanoparticles and the significantly improved overall stability of the PtCo nanocatalysts.

The high-resolution STEM image and EDX mapping also confirm that the PtCo nanoparticles in PtCo@Gnp at EOT retained its core-shell like structure with a Pt-rich shell (FIG. 4D). It is also noted that the protective pocket remained at EOT, but apparently collapsed onto the PtCo nanoparticles (FIGS. 4E, 4F, 7A-7B) with significantly reduced space in between. It is likely that graphene pockets become more hydrophilic after ADT and collapsed onto the PtCo nanoparticles due to capillary force during the TEM sample preparation steps. The much smaller increase of the mass-weighted size in PtCo@Gnp (from 3.4 nm to 5.1 nm) allows retaining relatively high ECSA of 32.4 m²/g_{PGM}, substantially higher than of Pt/C at EOT (13.2 m²/g_{PGM}) and c-PtCo/C (13.6 m²/g_{PGM}) (FIG. 4G, Table S2).

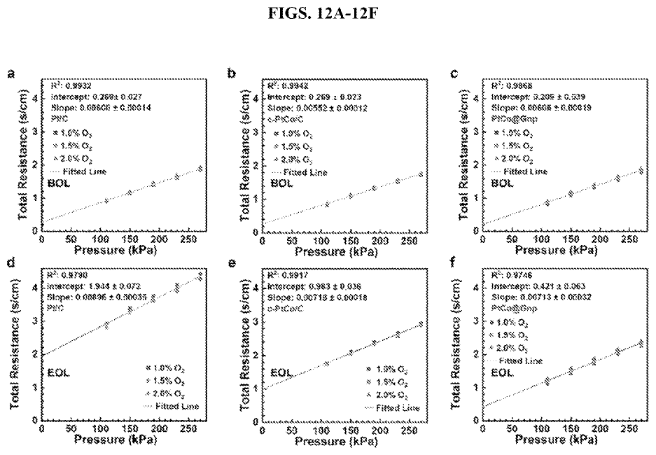

The ability to retain high ECSA in PtCo@Gnp catalysts during fuel cell operations can also be evidenced by the oxygen transport resistance studies since the pressure independent oxygen transport resistance (R^{P-Ind}) of an MEA is reversely linked to the number of active sites per unit area of the electrode (60, 61). In contrast to more than 600% increase of R^{P-Ind} in Pt/C after ADT, the PtCo@G showed a much smaller increase of approximately 100% (FIG. 4H, FIGS. 12A-12F). The dramatic increase in R^{P-Ind} for Pt/C electrode can be attributed to a seriously increased particle size (12.2 nm) reduced ECSA (13.2 m²/g_{PGM}) and a significantly reduced particle density (from 3.2×10¹³ to 6.2×10¹²/cm²), which lead to significantly increased resistance for oxygen diffusion to reach active sites (18). In contrast, the PtCo@G retains a relatively smaller size (5.1 nm), a respectable ECSA (32.4 m²/g_{PGM}) and a high particle density (4.5×10¹³/cm²) to ensure a sufficiently low R^{P-Ind}, which is essential for overall fuel cell performance (FIG. 4I).

Together, by encaging ultrafine nanocatalysts in monolayer graphene pockets, we have created a new design of PtCo@Gnp nanocatalysts that show superior stability against size aggregation to retain high ECSA during practical MEA operations, and thus enable highly robust ultralow PGM loading PEMFCs with a high mass activity (1.18 A/g_{PGM}), a rated power of 13.2 W/mg_{PGM} in H₂/Air test, and extraordinary durability with a high mass activity retention 72% only a 19.0 mV potential loss at 0.8 A/cm² after ADT, all exceeding the DOE technical targets. With the high rated power (13.2 W/mg_{PGM}), the developed PtCo@G can promise to substantially reduce the needed PGM in a 90-kW FCV to around 6.8 g, which is comparable to the PGM loading in the typical catalytic converters for internal combustion engine powered vehicles (3, 9). To the best of our knowledge, PtCo@G is the only catalyst demonstrated to be able to work in a fuel cell with ultralow PGM while meeting all DOE performance targets, especially in terms of stability, which holds potential for industrial application to enable widespread adoption of PEMFCs.

### Supporting Information—Materials and Methods

### Chemicals and Materials

Platinum (II) acetylacetonate [Pt(acac)₂] and Aquivion D83-06A ionomer dispersion were purchased from Sigma Aldrich. Cobalt (II) acetylacetonate [Co(acac)₂], commercial Pt/C (weight ratio of Pt: 10%), commercial Pt/C (weight ratio of Pt: 40%) were purchased from Alfa Aesar. Commercial PtCo/C (c-PtCo/C) catalyst was purchased from Premetek. N, N-Dimethylformamide (DMF), acetone, and isopropanol (IPA) were purchased from Fisher Scientific. Ethanol was purchased from Decon Labs, Inc. Freudenberg H14C7 gas diffusion layer (GDL), and polytetrafluoroethylene (PTFE) gasket were purchased from The Fuel Cell Store. Carbon black (Ketjen® Black EC-300J) was obtained from Fitz Chem LLC. The water used was Ultrapure Millipore (18.2 M (2·cm) and was generated by a Millipore equipment.

### Catalysts Preparation

### Preparation of Carbon Support

The carbon black support (Ketjen® Black EC-300J) is treated in hydrogen (H₂)/argon (Ar) mixture before use as noted in the literature (30).

### Synthesis of PiCo@Gnp

For a typical synthesis, 150 mg of carbon black, 150 mg of Pt(acac)₂, 190 mg of Co(acac)₂, and 10 mL of acetone were mixed in glass vial under ultrasonication for 10 min. Then acetone in the mixture was evaporated at room temperature. Powder of metal precursor adsorbed carbon black was obtained and finely ground.

The fine powder (metal precursor adsorbed carbon black) obtained from the above process was further annealed in a quartz tube in an H2/Ar mixture flowed through the quartz tube. The temperature was slowly heated from about 20° C. to 700° C. in 15 hours and maintained at 700° C. for six hours. The sample was collected after it was fully cooled to room temperature.

### Acid-Wash and Annealing

The synthesized PtCo@Gnp was further subjected to acid wash in N₂ saturated H₂SO₄ within a capped vial. The vial was kept at 85° C. for 16 hr. After acid washing, the catalyst was rinsed with ultrapure water and then redispersed in ultrapure water and collected via centrifugation 3-5 times, and the collected catalyst was dried under vacuum. The obtained catalyst was then annealed in H₂/Ar mixture, at 200° C. for 1.5-2.5 hr. The samples were collected after fully cool-down to room temperature.

The c-PtCo/C is also subjected to acid washing and further annealing under the same procedure to reduce the poison effect of leached metal cation during fuel cell operation. All catalysts were subjected to testing after the acid-wash and annealing.

### Characterization

Transmission electron microscopy (TEM) images were taken with an FEI T12 transmission electron microscope operated at 120 kV. Atomic resolution high angle annular dark-field (HAADF) images, as well as energy-dispersive spectroscopy (EDS) maps, were taken using a JEOL Grand ARM300CF scanning/transmission electron microscopy (S/TEM) operated at 300 kV. EDS analysis was also performed using an FEI TITAN. The atomic-resolution STEM-EELS experiments were conducted using the unique ultrahigh energy resolution monochromated and spherical aberration-corrected Nion UltraSTEM200, operated at 60 kV. The convergence semi-angle and the beam current were set as 38 mrad and ~15 pA, respectively. The low accelerating voltage and low beam current were used to mitigate the electron beam-induced damage on the sample, especially for carbon atoms. Several precautions were also employed during high-resolution STEM experiments to eliminate the electron beam-induced contamination and other artifacts: (1) After dispersing samples onto lacey carbon film coated copper TEM grids, we annealed the as-prepared TEM grids at 160° C. in a vacuum chamber for over 8 hours right before transferring them into Nion UltraSTEM200 electron microscope (64). Vacuum annealing can remove most of the residual solvent and other absorbed molecules, which are the major source of contamination in TEM; (2) High-resolution STEM experiments were only conducted when the pressure of the TEM column is lower than 2×10⁻⁹ Torr to ensure an ultraclean environment; and (3) During the STEM experiments, we carefully monitored the morphology of the observed nanoparticles and there were no obvious carbon deposits (contaminations) and shape changes. Therefore, we can exclude the carbon deposits and other artifacts that presumably occurred in TEM for explaining the formation of carbon shells covering Pt nanoparticles.

The EELS dispersion and dwell time were 0.28 eV/channel and 0.5 s/pixel, respectively. The pixel size of the STEM-EELS spectrum image was set as 0.20-0.34 nm, depending on the field of view. The data analysis of removing background was carried out by power-law function in the commercial software package Digital Micrograph. The TEM/STEM sample grids were prepared by dispersing the sample in a mixture of water and ethanol, then dripping the dispersion onto regular carbon film coated aluminum grids (for EDS analysis), regular carbon film coated copper grids, or lacey carbon film coated copper grids (for high-resolution STEM) using a pipette and drying under ambient condition. The elemental composition of catalysts was determined by inductively coupled plasma atomic emission spectroscopy (ICP-AES, Shimadzu ICPE-9000) as well as by energy-dispersive spectroscopy (EDS) coupled in FEI TITAN Transmission electron microscopy (TEM). X-ray photoelectron spectroscopy (XPS) tests were done with Kratos AXIS Ultra DLD spectrometer. X-ray powder diffraction (XRD) patterns were collected with a Panalytical X'Pert Pro X-ray Powder Diffractometer with Cu-Kα radiation as an incident beam.

### Rotating Disk Electrode Test

For the ink preparation, the catalyst powder (Pt/C, c-PtNi/C, PtCo@Gnp) was mixed with ethanol under ultrasonication for about 5 min. Then, ionomer dispersion was added to the ink, and the ratio of ionomer dispersion over the solvent (Nafion dispersion, 5 wt %) was fixed to be 8 μL/ml. After ultrasonication (1-2 min), the final ink was ready to use. 10 μL of prepared ink was then dropped onto a 5 mm diameter glassy carbon electrode and was dried in air. Then, the electrode was ready for the electrochemical test. For all studied catalysts, the platinum group metal (PGM) loading was fixed at about 3.2 μg for each tested electrode, which is estimated based on the overall PGM ratio within the catalyst (determined by ICP-AES). The electrochemical measurements were performed in a three-electrode system, which includes a working electrode, a counter electrode, and a reference electrode. The working electrode glassy carbon electrode loaded with catalyst as described above. An Ag/AgCl electrode and a Pt wire were used as the reference electrode and counter electrode, respectively. Cyclic Voltammetry (CV) measurements were conducted in an N₂ saturated 0.1 M HClO₄ solution between 0.05 to 1.1 V vs. reversible hydrogen electrode (RHE) at a sweep rate of 100 mV/s. Electrochemical active surface area (ECSA) was measured by integrating the hydrogen underpotential deposition (H_{upd}) peak in CV, assuming 210 μC/cm². Oxygen reduction reaction (ORR) tests were conducted in an O₂ saturated 0.1 M HClO₄ solution with a linear voltage scan at a sweep rate of 20 mV/s.

### MEA Fabrication and MA, ECSA Test

A series of catalysts were investigated as the cathode catalyst layers in MEA testing. In general, the fabrication of membrane electrode assembly (MEA) followed the established protocol noted in our previous work (30). The catalyst inks were made by mixing the catalysts with the ionomer solution (Aquivion D83-06A) and water-IPA solvent through ultrasonication. The fresh inks were then spray-coated onto a reinforced perfluorosulfonic acid (PFSA) membrane (12 μm thickness) by using a Sono-Tek ultrasonic spray system. Anode catalyst is Pt/C (weight ratio of Pt: 10%). The ionomer to carbon ratio was 0.6. The PGM loading at the anode was fixed to be 0.01 mg_{PGM}/cm². The cathode catalyst included Pt/C (weight ratio of Pt: 40%), and PtCo@G. The ionomer to carbon ratio was 0.6 for Pt/C, while 0.7 for PtCo@G. The cathode catalyst loading was controlled to be 0.09 or 0.06 mg_{PGM}/cm². Both anode and cathode loading were confirmed by the ICP-AES measurements. The fabricated CCM was dried in a vacuum desiccator to evaporate the solvents before assembly. Two gas diffusion layers (GDLs), two PTFE gaskets, and the prepared CCM were pressed to make the MEA. The thickness of the PTFE gasket is 127 μm (5 mil). The thickness of GDL, which includes a microporous layer, is 175 μm (Freudenberg H14C7).

The MEA(s) was then loaded into a Fuel Cell Technology 5 cm² single-cell hardware and tested in the Scribner 850e fuel cell test stand. The MEA was initially activated by holding the potential at 0.5 V under H₂/Air flow (100/100 sccm) at 80° C., 150 kPa_{abs} (abs: absolute; all pressure noted in this work refer to the absolute pressure) and 100% relative humidity (RH). Then, the MEA was further activated at a high humidity condition, which let both cathode and anode gas passing a corresponding humidifier at 80° C. before entering the fuel cell (hold at 60° C.). The mass activity was tested at 80° C., 150 kPa_{abs}, 100% RH, with a gas flow rate of 1500 (H₂)/2000 (O₂) sccm for anode/cathode. The accelerated durability test (ADT) included 30000 cycles of square wave with each cycle holding the MEA at the voltage of 0.6 V for 3 seconds and then 0.95 V for 3 seconds, according to the DOE MEA ADT protocol for PGM based catalysts. The full ADT is carried at 80° C., 150 kPa_{abs}, 100% RH with H₂/N₂ flow 100/100 sccm for anode and cathode, respectively. Note that the square wave protocol demonstrates a five times acceleration effect compared to the previously used triangle wave protocol in terms of the degradation of catalyst at a given period, which represents a more aggressive test protocol to better simulate the lifetime degradation of catalysts (65). The MEA's beginning of test (BOT) and end of test (EOT) performance metrics, such as MA, ECSA, and H2 crossover, were recorded by the Scribner 850e fuel cell test station and the Scribner 885 potentiostat associated with the 850e fuel cell station. The ECSA was determined by integrating the CO stripping peak, assuming 420 μC/cm²_{PGM}. The CO stripping testing protocol was generally followed literature (35).

### Rated Power Test for MEA

The BOT and EOT rated power of prepared MEA was tested in Scribner 850e fuel cell test stand under 94° C., 250 kPa_{abs}, and 100% RH (3). The H2/Air gas flow rate was 126/400 sccm for anode/cathode, which is equivalent to stoichiometry of 1.5/2.0 at the 2.4 A/cm² (end of current density plot). The ADT test between BOT and EOT is the same as noted in the above section.

The DOE assumes 90 kW stack gross power (P_{stack}) required for 80 kW net power and sets a heat rejection target, Q/ΔTᵢ of <1.45. The rated power was measured at rated voltage (V_{rated}), which can be defined by the following equation 1 (Eq. 1) (3).

$$\frac{Q}{Δ {T}_{i}} = \frac{{P}_{stack} ( 1.25 - {V}_{rated} )}{{V}_{rated} ( {T}_{stack} - {T}_{ambient} )} \qquad Eq . 1$$

The DOE protocol assumes P_{stack}=90 KW and T_{ambient}=40° C., if T_{stack}=94° C., Q/ΔTᵢ=1.445, which meets the target (Q/ΔTᵢ of ≤1.45), the V_{rated} will be around 0.67 V. Thus, the rated power will be measured at 0.67 V. (3)

### Oxygen Transport Resistance Test for MEA

The MEA was tested at 80° C. with 65% RH for both anode and cathode. Ultrahigh pure hydrogen was applied in the anode. The mix-gases (O₂ and N₂) were pre-mixed by Airgas, Inc., and the mix-gas cylinders were used as a gas source. The dry O₂ mole ratios for pre-mixed gases were 0.981%, 1.491%, and 2.001%, which was determined by Airgas, Inc. To identify the pressure independent part of the total oxygen transport resistance, the test was performed at a total pressure of 110, 150, 190, 230, and 270 kPa_{abs}. The total oxygen transport resistance can be approximately obtained by the following Eq. 2.

$${R}_{total} = \frac{4 {FC}_{{O}_{2}}}{{i}_{lim}} = \frac{4 F}{{i}_{lim}} \times \frac{{P}_{abs} - {P}_{{H}_{2} O}}{RT} \times {x}_{{O}_{2} - dry} \qquad Eq . 2$$

Note:

$${R}_{t o t a l}^{{O}_{2}}$$

represents the total oxygen transport resistance. C_{O}_{₂} represents oxygen concentration. P_{abs} is the total pressure. P_{H}_{₂}_{O} is the pressure of water vapor at testing temperature. x_{O}_{₂}—dry is the dry O₂ ratio. iₗᵢₘ represents the limit current density.

The limit current density was identified as the largest current density (considering the absolute value) obtained through linear voltage sweep (0.12 to 0.41 V, 2 mV/s) using the 885 potentiostat attached to the 850e fuel cell station. The total oxygen transport resistance can be separated into pressure-dependent part (R^{P-d}) and pressure-independent part (R^{P-ind}), which represents the Knudsen diffusion and diffusion of oxygen through the ionomer layer (36, 37). The relationship of total oxygen resistance (Rₜₒₜₐₗ), pressure-dependent part of oxygen transport resistance (R^{P-d}), and pressure-independent part of oxygen transport resistance (R^{P-ind}) can be expressed in the following Eq. 3.

$${R}_{t o t a l} = {R}^{P - d} + {R}^{P - ind} \qquad Eq . 3$$

### Estimation of Size Distribution Weighted by Mass

By assuming a spherical model using the measured size as diameter, we can estimate the relative volume and the relative mass of each nanoparticle to obtain the mass-weighted size distribution, which gives mass fraction contributed by nanoparticles of different sizes (Table S1). The weighted average size (d̅_{w}) is obtained by the following Eq. 4. The dᵢ, mᵢ, Vᵢ, and ρ are the size, mass, volume, and density of that nanoparticle, correspondingly.

$${\overline{d}}_{w} = \frac{{Σ}_{1}^{n} {d}_{i} {m}_{i}}{{Σ}_{1}^{n} {m}_{i}} = \frac{{ρΣ}_{1}^{n} {d}_{i} {V}_{i}}{{ρΣ}_{1}^{n} {V}_{i}} = \frac{{Σ}_{1}^{n} {d}_{i} {V}_{i}}{{Σ}_{1}^{n} {V}_{i}} \qquad Eq . 4$$

### Estimation of Theoretical Limit of ECSA

We estimated the theoretical limit of ECSA based on the statics of nanoparticle size. A spherical model to estimate the surface Pt area and the Pt mass of each nanoparticle. The ECSA is defined as the sum of accessible surface Pt area of all nanoparticles divided by the sum of Pt mass of all nanoparticles (Eq. 5).

$$ECSA = \frac{{A}_{Pt}}{{m}_{Pt}} = \frac{b {Σ}_{i = 1}^{n} 4 {π ( \frac{{d}_{i}}{2} )}^{2}}{{ρ}_{P t} ( {Σ}_{i = 1}^{n} \frac{4}{3} {π ( \frac{{d}_{i}}{2} )}^{3} )} \qquad Eq . 5$$

Apt is the total surface Pt area and m_{Pt} is the total Pt mass. The di is the diameter of a nanoparticle and the i represents a number from 1 to n (n is the total number of nanoparticles). The b is a constant that represents the ratio of accessible surface since some part of the surface is attached with the support. We assumed b to be 0.75. The ρ_{Pt} is the mass of Pt per unit volume, which can be estimated from the lattice parameter and the Pt ratio (Eq. 6). The a is the lattice parameter of a unit cell and a can be estimated based on Vegard's law for an alloy sample. The unit cell of face-centered cubic (fcc) packing contains 4 atoms. The c is the average ratio of Pt atoms within a unit cell and is based on the EDS analysis result in Table S4. M_{Pt} is the molar mass of Pt. N_{A} is Avogadro constant.

$${ρ}_{Pt} = \frac{4 c {M}_{P t}}{{N}_{A} {a}^{3}} \qquad Eq . 6$$

Note that the only PGM contained in the nanoparticles is Pt. Thus, we can use Pt to represent the PGM. The estimated theoretical limit of ECSA is listed in Table S3.

In addition, for a single nanoparticle, we can also estimate the relation between ECSA and the size (diameter d) of a nanoparticle using a spherical model (Eq. 7). The definition of b and ppt in Eq. 7 is the same as Eq. 5. Since b and ppt are both constants for a given nanoparticle, we further simplified the equation using a C to represent all constants (C=6b/ρ_{Pt}). There is a clear inverse relationship between ECSA and size (diameter d), as reflected in FIG. 1A.

$$ECSA = \frac{b 4 {π ( \frac{d}{2} )}^{2}}{{ρ}_{Pt} \frac{4}{3} {π ( \frac{d}{2} )}^{3}} = \frac{6 b}{{ρ}_{Pt} d} = \frac{C}{d} \qquad Eq . 7$$

### Estimation of Nanoparticle Density

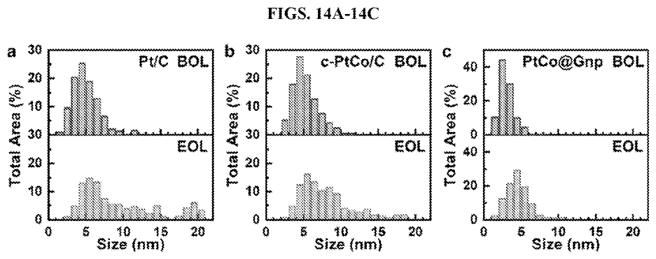

Assuming a spherical shape for a given nanoparticle, we can obtain the sum of the surface area of all nanoparticles (Eq. 8) and the contribution of each nanoparticle to the total surface area (Eq. 9). Then, based on the statics, we can obtain the size distribution of nanoparticles weighted by their surface area (FIGS. 14A-14C).

$${A}_{total} = {Σ}_{1}^{n} {A}_{i} = {Σ}_{1}^{n} 4 {π ( \frac{{d}_{i}}{2} )}^{2} \qquad Eq . 8$$

$${F}_{i} = \frac{{A}_{i}}{{A}_{total}} \qquad Eq . 9$$

The Aₜₒₜₐₗ represents the total surface area. The Aᵢ represents the surface area of nanoparticle i (i represents an integer from 1 to n). The dᵢ represents the diameter of nanoparticle i. The Fᵢ represents the contribution ratio of a given nanoparticle to the total surface area.

The theoretical density of nanoparticles within the MEA cathode can be estimated based on the measured ECSA. We can first obtain the electrochemical surface area per unit area of the electrode by multiplying the ECSA with cathode loading. Then, the total electrochemical surface area can be distributed to each size of nanoparticle according to its contribution to the total surface area (Fᵢ) (Eq. 10). Then, the density of nanoparticle of each size (Nᵢ) can be obtained via dividing the distributed electrochemical area of the size (Eᵢ) by the electrochemical surface area of a nanoparticle at the size (4πb(dᵢ/2)²). The total density of nanoparticle Nₜₒₜₐₗ can be obtained by summing up the Nᵢ (Eq. 11).

$${E}_{i} = ECSA \times PGM loading \times {F}_{i} \qquad Eq . 10$$

$${N}_{total} = Σ {N}_{i} = Σ \frac{{E}_{i}}{4 π {b ( \frac{{d}_{i}}{2} )}^{2}} \qquad Eq . 11$$

The Eᵢ is the electrochemical surface area of a given size. Nₜₒₜₐₗ is the density of nanoparticles in an electrode. Nᵢ represents the density of nanoparticles of a given size. The di here represents the diameter of a given nanoparticle. The b is a constant that represents the ratio of accessible surface since some part of the surface is attached with the support. We assumed b to be 0.75 same as the above section of ECSA estimation.

TABLE S1
The comparison of analysis results of average size and weighted average size count
the mass of each nanoparticle.

| | Average Size (nm) | | |
|---|---|---|---|
| | | Beginning of Test | End of Test |
| Catalyst | Before Test | (BOT) | (EOT) |
| Pt/C | 3.8 ± 1.1 | 3.9 ± 1.5 | 5.8 ± 2.9 |
| c-PtCo/C | 4.2 ± 1.2 | 4.3 ± 1.4 | 5.7 ± 2.4 |
| PtCo@G | 2.3 ± 0.7 | 2.6 ± 0.8 | 3.6 ± 1.4 |
| | Weighted Average Size (nm)* | | |
| Pt/C | 4.9 ± 1.5 | 5.7 ± 2.0 | 12.2 ± 5.6 |
| c-PtCo/C | 5.7 ± 1.7 | 5.8 ± 1.8 | 9.5 ± 4.0 |
| PtCo@G | 3.0 ± 0.8 | 3.4 ± 1.1 | 5.1 ± 1.7 |

*The average size is weighted by the estimated mass of each nanoparticle. By assuming a fixed density, the mass of a given nanoparticle can be obtained based on its volume. The volume is estimated by assuming a spherical shape use the measured size as the diameter of the spherical model. The weighted average size
(d̅_{w}) is obtained by the following equation. dᵢ, mᵢ, Vᵢ, and ρ is the size, mass, volume, and density of that nanoparticle, correspondingly.
${\overline{d}}_{w} = \frac{{\sum }_{i}^{n} {d}_{i} {m}_{i}}{{\sum }_{1}^{n} {m}_{i}} = \frac{ρ {\sum }_{1}^{n} {d}_{i} {V}_{i}}{ρ {\sum }_{1}^{n} {V}_{i}} = \frac{{\sum }_{1}^{n} {d}_{i} {V}_{i}}{{\sum }_{1}^{n} {V}_{i}}$

TABLE S2
Comparison of ECSA of catalysts at both BOT and EOT.

ECSA (m²/g_{PGM})

| Catalysts | BOT | EOT |
|---|---|---|
| Pt/C | 34.7 | 13.2 |
| c-PtCo/C | 41.5 | 13.6 |
| PtCo@G | 68.7 | 32.4 |

TABLE S3
Estimated the theoretical limit of the
ECSA at both BOT and EOT of MEA tests.

ECSA (m²/g_{PGM})

| Catalysts | BOT | EOT |
|---|---|---|
| Pt/C | 41.9 | 22.3 |
| c-PtCo/C | 44.8 | 28.2 |
| PtCo@G | 75.3 | 48.5 |

TABLE S4
The composition of PtCo@G measured
by EDS at both BOT and EOT of MEA tests.

EDS atomic ratio (%)

| | Pt | Co |
|---|---|---|
| PtCo@G BOT | 87.0 | 13.0 |
| PtCo@G EOT | 91.6 | 8.4 |
| c-PtCo/C BOT | 85.0 | 15.0 |
| c-PtCo/C EOT | 90.5 | 9.5 |

### Synthesis of Ultrafine Platinum Nickel Nanocatalysts

130-150 mg carbon black, 130-150 mg platinum (II) acetylacetonate [Pt(acac)₂], 100-180 mg nickel (II) acetylacetonate [Ni(acac)₂], and 5 mL acetone was mixed in 35 mL glass vial under ultrasonication for 10 min, followed by evaporation. The evaporation of acetone can be done at the condition of ambient pressure and temperature, vacuum with ambient temperature, or supercritical condition at a supercritical dryer. Powder of metal precursor adsorbed carbon black was obtained and finely ground. The fine powder (metal precursor adsorbed carbon black) obtained from the above process was subjected to annealing. The powder (1-2 g) was loaded in a quartz boat and placed in a quartz tube. The powders were annealed in an H₂/Ar mixture (H₂ volume ratio is 0.2-2.0%). The temperature was raised from about 20° C. to 700° C. in 12-20 hour (“hr”) and maintained at 700° C. for 8-16 hr. Then the quartz tube with the sample was cooled down to room temperature under the protection of Ar. When the sample was fully cooled to room temperature, the quartz boat loaded with the sample was slowly taken out from the quartz tube.

After the above annealing step, the obtained catalyst was further subject to acid wash. 200 mg of obtained catalyst powder was dispersed in 20 mL of N₂ saturated 0.2 M H₂SO₄ within a 35 ml capped vial. The vial was kept at 80-90° C. for 12-16 hr. After acid wash, the catalyst was rinsed by ultrapure water and then redispersed in ultrapure water and collected via centrifugation. Then the collected catalyst was dried in in vacuum.

After thorough drying, dry catalyst was loaded in a quartz boat and placed in a quartz tube, and annealed in H₂/Ar mixture (H₂ volume ratio is 0.2-2.0%). The tube is slowly heated from about 20° C. to 200° C. in 1.5 hr and maintained at 200° C. for 1.5-2.5. Then the samples slowly cooled down to room temperature under the protection of Ar. When the sample was fully cooled to room temperature, the quartz boat loaded with the sample was slowly taken out from the quartz tube.

The obtained platinum nickel nanocatalysts were characterized in the same manner as described for the above platinum cobalt nanocatalysts. The platinum nickel nanocatalysts have a mass-weighted average size of 3.2±1.0 nm, delivered a mass activity of 1.09 A/mg_{PGM} in membrane electrode assembly, provided a rated power of 13.8 W/mg_{PGM} in H₂/Air test, and retained 61% of its initial activity after accelerated durability test (ADT).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only and it is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### CITED REFERENCES

1. M. K. Debe, Electrocatalyst approaches and challenges for automotive fuel cells. Nature 486, 43-51 (2012).
2. H. Hao, Y. Geng, J. E. Tate, F. Liu, X. Sun, Z. Mu, D. Xun, Z. Liu, F. Zhao, Securing Platinum-Group Metals for Transport Low-Carbon Transition. One Earth 1, 117-125 (2019).
3. V. Yarlagadda, M. K. Carpenter, T. E. Moylan, R. S. Kukreja, R. Koestner, W. Gu, L. Thompson, A. Kongkanand, Boosting Fuel Cell Performance with Accessible Carbon Mesopores. ACS Energy. Lett. 3, 618-621 (2018).
4. J. Tollefson, Worth its weight in platinum. Nature 450, 334-335 (2007).
5. H. Dong, J. Zhao, J. Chen, Y. Wu, B. Li, Recovery of platinum group metals from spent catalysts: A review. Int. J. Miner. Process. 145, 108-113 (2015).
6. B. D. James, J. M. Huya-Kouadio, C. Houchins, D. A. DeSantis, “Mass Production Cost Estimation of Direct H2 PEM Fuel Cell Systems for Transportation Applications: 2018 Update” (US Department of Energy, 2018 https://www.energy.gov/eere/fuelcells/downloads/mass-production-cost-estimation-direct-h2-pem-fuel-cell-systems-3).
7. B. G. Pollet, S. S. Kocha, I. Staffell, Current status of automotive fuel cells for sustainable transport. Current Opinion in Electrochemistry 16, 90-95 (2019).
8. O. Gröger, H. A. Gasteiger, J.-P. Suchsland, Review—Electromobility: Batteries or Fuel Cells? J. Electrochem. Soc. 162, A2605-A2622 (2015).
9. A. Kongkanand, M. F. Mathias, The Priority and Challenge of High-Power Performance of Low-Platinum Proton-Exchange Membrane Fuel Cells. J. Phys. Chem. Lett. 7, 1127-1137 (2016).
10. U.S. Department of Energy “DOE Technical Targets for Polymer Electrolyte Membrane Fuel Cell Components” https://energy.gov/eere/fuelcells/doe-technical-targets-polymer-electrolyte-membrane-fuel-cell-components (accessed Jun. 11 2021).
11. M. Escudero-Escribano, P. Malacrida, M. H. Hansen, U. G. Vej-Hansen, A. Velázquez-Palenzuela, V. Tripkovic, J. Schiøtz, J. Rossmeisl, I. E. L. Stephens, I. Chorkendorff, Tuning the activity of Pt alloy electrocatalysts by means of the lanthanide contraction. Science 352, 73-76 (2016).
12. W. Li, Z. Chen, L. Xu, Y. Yan, A solution-phase synthesis method to highly active Pt—Co/C electrocatalysts for proton exchange membrane fuel cell. J. Power Sources 195, 2534-2540 (2010).
13. C. Chen, Y. Kang, Z. Huo, Z. Zhu, W. Huang, H. L. Xin, J. D. Snyder, D. Li, J. A. Herron, M. Mavrikakis, M. Chi, K. L. More, Y. Li, N. M. Markovic, G. A. Somorjai, P. Yang, V. R. Stamenkovic, Highly Crystalline Multimetallic Nanoframes with Three-Dimensional Electrocatalytic Surfaces. Science 343, 1339-1343 (2014).
14. J. Greeley, I. E. L. Stephens, A. S. Bondarenko, T. P. Johansson, H. A. Hansen, T. F. Jaramillo, J. Rossmeisl, I. Chorkendorff, J. K. Nørskov, Alloys of platinum and early transition metals as oxygen reduction electrocatalysts. Nat. Chem. 1, 552-556 (2009).
15. Z. W. Seh, J. Kibsgaard, C. F. Dickens, I. Chorkendorff, J. K. Nørskov, T. F. Jaramillo, Combining theory and experiment in electrocatalysis: Insights into materials design. Science 355, eaad4998 (2017).
16. M. Li, Z. Zhao, T. Cheng, A. Fortunelli, C.-Y. Chen, R. Yu, Q. Zhang, L. Gu, B. V. Merinov, Z. Lin, E. Zhu, T. Yu, Q. Jia, J. Guo, L. Zhang, W. A. Goddard, Y. Huang, X. Duan, Ultrafine jagged platinum nanowires enable ultrahigh mass activity for the oxygen reduction reaction. Science 354, 1414-1419 (2016).
17. K. Kodama, T. Nagai, A. Kuwaki, R. Jinnouchi, Y. Morimoto, Challenges in applying highly active Pt-based nanostructured catalysts for oxygen reduction reactions to fuel cell vehicles. Nat. Nano. 16, 140-147 (2021).
18. A. Z. Weber, A. Kusoglu, Unexplained transport resistances for low-loaded fuel-cell catalyst layers. J. Mater. Chem. A 2, 17207-17211 (2014).
19. E. F. Holby, W. Sheng, Y. Shao-Horn, D. Morgan, Pt nanoparticle stability in PEM fuel cells: influence of particle size distribution and crossover hydrogen. Energy Environ. Sci. 2, 865-871 (2009).
20. R. L. Borup, A. Kusoglu, K. C. Neyerlin, R. Mukundan, R. K. Ahluwalia, D. A. Cullen, K. L. More, A. Z. Weber, D. J. Myers, Recent developments in catalyst-related PEM fuel cell durability. Current Opinion in Electrochemistry 21, 192-200 (2020).
21. B. Han, C. E. Carlton, A. Kongkanand, R. S. Kukreja, B. R. Theobald, L. Gan, R. O'Malley, P. Strasser, F. T. Wagner, Y. Shao-Horn, Record activity and stability of dealloyed bimetallic catalysts for proton exchange membrane fuel cells. Energy Environ. Sci. 8, 258-266 (2015).
22. J. P. Braaten, X. Xu, Y. Cai, A. Kongkanand, S. Litster, Contaminant Cation Effect on Oxygen Transport through the Ionomers of Polymer Electrolyte Membrane Fuel Cells. J. Electrochem. Soc. 166, F1337-F1343 (2019).
23. M. Sulek, J. Adams, S. Kaberline, M. Ricketts, J. R. Waldecker, In situ metal ion contamination and the effects on proton exchange membrane fuel cell performance. J. Power Sources 196, 8967-8972 (2011).
24. B. M. Sperry, C. K. Luscombe, Ligand Pyrolysis during Air-Free Inorganic Nanocrystal Synthesis. Chem. Mater. 33, 136-145 (2021).
25. L. Tang, X. Li, R. C. Cammarata, C. Friesen, K. Sieradzki, Electrochemical Stability of Elemental Metal Nanoparticles. J. Am. Chem. Soc. 132, 11722-11726 (2010).
26. L. Tang, B. Han, K. Persson, C. Friesen, T. He, K. Sieradzki, G. Ceder, Electrochemical Stability of Nanometer-Scale Pt Particles in Acidic Environments. J. Am. Chem. Soc. 132, 596-600 (2010).
27. D. A. Cullen, K. C. Neyerlin, R. K. Ahluwalia, R. Mukundan, K. L. More, R. L. Borup, A. Z. Weber, D. J. Myers, A. Kusoglu, New roads and challenges for fuel cells in heavy-duty transportation. Nat. Energy. 6, 462-474 (2021).
28. U.S. Department of Energy “Fuel Cell Technologies Office Multi-Year Research, Development, and Demonstration Plan” https://www.energy.gov/eere/fuelcells/downloads/fuel-cell-technologies-office-multi-year-research-development-and-22 (accessed Jun. 11 2021).
29. S. Stariha, N. Macauley, B. T. Sneed, D. Langlois, K. L. More, R. Mukundan, R. L. Borup, Recent Advances in Catalyst Accelerated Stress Tests for Polymer Electrolyte Membrane Fuel Cells. J. Electrochem. Soc. 165, F492-F501 (2018).
30. Z. Zhao, M. D. Hossain, C. Xu, Z. Lu, Y.-S. Liu, S.-H. Hsieh, I. Lee, W. Gao, J. Yang, B. V. Merinov, W. Xue, Z. Liu, J. Zhou, Z. Luo, X. Pan, F. Zaera, J. Guo, X. Duan, W. A. Goddard, Y. Huang, Tailoring a Three-Phase Microenvironment for High-Performance Oxygen Reduction Reaction in Proton Exchange Membrane Fuel Cells. Matter 3, 1774-1790 (2020).
31. L. Chong, J. Wen, J. Kubal, F. G. Sen, J. Zou, J. Greeley, M. Chan, H. Barkholtz, W. Ding, D.-J. Liu, Ultralow-loading platinum-cobalt fuel cell catalysts derived from imidazolate frameworks. Science 362, 1276-1281 (2018).
32. Q. Jia, K. Caldwell, K. Strickland, J. M. Ziegelbauer, Z. Liu, Z. Yu, D. E. Ramaker, S. Mukerjee, Improved Oxygen Reduction Activity and Durability of Dealloyed PtCox Catalysts for Proton Exchange Membrane Fuel Cells: Strain, Ligand, and Particle Size Effects. ACS Catal. 5, 176-186 (2015).
33. J. Li, S. Sharma, X. Liu, Y.-T. Pan, J. S. Spendelow, M. Chi, Y. Jia, P. Zhang, D. A. Cullen, Z. Xi, H. Lin, Z. Yin, B. Shen, M. Muzzio, C. Yu, Y. S. Kim, A. A. Peterson, K. L. More, H. Zhu, S. Sun, Hard-Magnet L10-CoPt Nanoparticles Advance Fuel Cell Catalysis. Joule 3, 124-135 (2019).
34. Z. Zhao, C. Chen, Z. Liu, J. Huang, M. Wu, H. Liu, Y. Li, Y. Huang, Pt-Based Nanocrystal for Electrocatalytic Oxygen Reduction. Adv. Mater. 31, 1808115 (2019).
35. T. R. Garrick, T. E. Moylan, M. K. Carpenter, A. Kongkanand, Editors' Choice—Electrochemically Active Surface Area Measurement of Aged Pt Alloy Catalysts in PEM Fuel Cells by CO Stripping. J. Electrochem. Soc. 164, F55-F59 (2016).
36. D. R. Baker, D. A. Caulk, K. C. Neyerlin, M. W. Murphy, Measurement of Oxygen Transport Resistance in PEM Fuel Cells by Limiting Current Methods. J. Electrochem. Soc. 156, B991-B1003 (2009).
37. Y. Garsany, R. W. Atkinson, B. D. Gould, K. E. Swider-Lyons, High power, Low-Pt membrane electrode assemblies for proton exchange membrane fuel cells. J. Power Sources 408, 38-45 (2018).
38. Bossi, T. & Gediga, J. The environmental profile of platinum group metals. Johnson Matthey Technology Review 61, 111-121 (2017).
39. Zhang, L. et al. Platinum-based nanocages with subnanometer-thick walls and well-defined, controllable facets. Science 349, 412-416 (2015).
40. Cui, C., Gan, L., Heggen, M., Rudi, S. & Strasser, P. Compositional segregation in shaped Pt alloy nanoparticles and their structural behaviour during electrocatalysis. Nature Materials 12, 765-771 (2013).
41. Zhang, Z. et al. One-pot synthesis of highly anisotropic five-fold-twinned PtCu nanoframes used as a bifunctional electrocatalyst for oxygen reduction and methanol oxidation. Advanced Materials 28, 8712-8717 (2016).
42. Wang, X. X. et al. Ordered Pt3 Co intermetallic nanoparticles derived from metal-organic frameworks for oxygen reduction. Nano Letters 18, 4163-4171 (2018).
43. Huang, L., Zheng, C. Y., Shen, B. & Mirkin, C. A. High-index-facet metal-alloy nanoparticles as fuel cell electrocatalysts. Advanced Materials 32, 2002849 (2020).
44. Ott, S. et al. Ionomer distribution control in porous carbon-supported catalyst layers for high-power and low Pt-loaded proton exchange membrane fuel cells. Nature Materials 19, 77-85 (2019).
45. Qiao, Z. et al. 3D porous graphitic nanocarbon for enhancing the performance and durability of Pt catalysts: a balance between graphitization and hierarchical porosity. Energy & Environmental Science 12, 2830-2841 (2019).
46. Wang, L. et al. Tunable intrinsic strain in two-dimensional transition metal electrocatalysts. Science 363, 870-874 (2019).
47. Wang, C. et al. Synthesis of homogeneous Pt-bimetallic nanoparticles as highly efficient electrocatalysts. ACS Catalysis 1, 1355-1359 (2011).
48. He, D. S. et al. Ultrathin Icosahedral Pt-Enriched Nanocage with Excellent Oxygen Reduction Reaction Activity. Journal of the American Chemical Society 138, 1494-1497 (2016).
49. Pizzutilo, E. et al. The Space Confinement Approach Using Hollow Graphitic Spheres to Unveil Activity and Stability of Pt—Co Nanocatalysts for PEMFC. Advanced Energy Materials 7, 1700835 (2017).
50. Mezzavilla, S. et al. Structure-Activity-Stability Relationships for Space-Confined PtxNiy Nanoparticles in the Oxygen Reduction Reaction. ACS Catalysis 6, 8058-8068 (2016).
51. Du, L. et al. Low-PGM and PGM-free catalysts for proton exchange membrane fuel cells: stability challenges and material solutions. Advanced Materials 33, 1908232 (2021).
52. Hoene, J. V., Charles, R. G. & Hickam, W. M. Thermal Decomposition of Metal Acetylacetonates: Mass Spectrometer Studies. The Journal of Physical Chemistry 62, 1098-1101 (1958).
53. Grimm, S. et al. Gas-phase aluminium acetylacetonate decomposition: revision of the current mechanism by VUV synchrotron radiation. Physical Chemistry Chemical Physics 23, 15059-15075 (2021).
54. Fei, L.-f. et al. Direct observation of carbon nanostructure growth at liquid-solid interfaces. Chemical Communications 50, 826-828 (2014).
55. Picher, M., Lin, P. A., Gomez-Ballesteros, J. L., Balbuena, P. B. & Sharma, R. Nucleation of Graphene and Its Conversion to Single-Walled Carbon Nanotubes. Nano Letters 14, 6104-6108 (2014).
56. Fan, H. et al. Dynamic State and Active Structure of Ni—Co Catalyst in Carbon Nanofiber Growth Revealed by in Situ Transmission Electron Microscopy. ACS Nano 15, 17895-17906 (2021).
57. Papadias, D. D. et al. Durability of Pt—Co alloy polymer electrolyte fuel cell cathode catalysts under accelerated stress tests. Journal of The Electrochemical Society 165, F3166-F3177 (2018).
58. Slack, J. J. et al. Nanofiber fuel cell MEAs with a PtCo/C cathode. Journal of The Electrochemical Society 166, F3202-F3209 (2019).
59. Kleen, G. & Padgett, E. Durability-Adjusted Fuel Cell System Cost. (US Department of Energy, 2021).
60. Baker, D. R., Caulk, D. A., Neyerlin, K. C. & Murphy, M. W. Measurement of oxygen transport resistance in PEM Fuel cells by limiting current methods. Journal of The Electrochemical Society 156, B991-B1003 (2009).
61. Garsany, Y., Atkinson, R. W., Gould, B. D. & Swider-Lyons, K. E. High power, Low-Pt membrane electrode assemblies for proton exchange membrane fuel cells. Journal of Power Sources 408, 38-45 (2018).
62. Papageorgopoulos, D. Fuel Cell R&D Overview. (US Department of Energy, 2019).
63. Kongkanand, A. Highly accessible catalysts for durable high power performance. (US Department of Energy, 2020)
64. Huang, P. Y. et al. Grains and grain boundaries in single-layer graphene atomic patchwork quilts. Nature 469, 389-392, (2011).
65. Stariha, S. et al. Recent advances in catalyst accelerated stress tests for polymer electrolyte membrane fuel cells. J. Electrochem. Soc. 165, F492-F501, (2018).
66. Yarlagadda, V. et al. Boosting fuel cell performance with accessible carbon mesopores. ACS Energy. Lett. 3, 618-621, (2018).

Other embodiments are set forth in the following claims.

1. A catalyst comprising nanoparticles each having a core-shell structure and a porous carbon layer over the shell, wherein the core comprises a non-platinum transition metal, and the shell comprises platinum.

2. The catalyst of claim 1, wherein the porous carbon layer is derived from carbon black, graphene, reduced graphene oxide, graphene oxide, and carbon nanotubes (CNT).

3. The catalyst of claim 1, wherein the porous carbon layer is derived from carbon black.

4. The catalyst of claim 1, wherein the non-platinum transition metal is V, Cr, Mn, Fe, Co, Ni, Cu, Zn, or a mixture of any two or more thereof.

5. The catalyst of claim 1, wherein the non-platinum transition metal comprises Co.

6. The catalyst of claim 5, wherein the non-platinum transition metal is derived from cobalt (II) acetylacetonate [Co(acac)₂].

7. The catalyst of claim 1, wherein the non-platinum transition metal comprises Ni.

8. The catalyst of claim 7, wherein the non-platinum transition metal precursor is derived from nickel (II) acetylacetonate [Ni(acac)₂].

9. The catalyst of claim 1, wherein the platinum is derived from platinum (II) acetylacetonate [Pt(acac)₂].

10. The catalyst of claim 1, wherein the nanoparticles have a mass-weighted average size of about 2 nm to about 4 nm.

11. (canceled)

12. The catalyst of claim 1, wherein the nanoparticles have a Pt:non-platinum transition metal atomic ratio of from about 80:20 to about 90:10.

13. The catalyst of claim 1, wherein the nanoparticles have a Pt:non-platinum transition metal atomic ratio of from about 80:20 to about 95:5.

14. The catalyst of claim 1, wherein the catalyst has a face-centered cubic (fcc) structure.

15. The catalyst of claim 1, wherein the catalyst has an electrochemical surface area (ECSA) of at least about 34 m²/g_{PGM}.

16. The catalyst of claim 15, wherein the catalyst has an ECSA of about 68 m²/g_{PGM}.

17. A fuel cell comprising a catalyst electrode layer comprising the catalyst of claim 1.

18. The fuel cell of claim 17 that is a proton exchange membrane fuel cell (PEMFCs).

19. The catalyst of claim 1, wherein the catalyst exhibits one or more of the following:
(a) a minimum mass activity (MA) of at least about 0.44 A/mg_{PGM};
(b) a rated power of at least about 8 W/mg_{PGM} (when using air as the oxygen source);
(c) an end-of-life MA retention of at least about 60% after square wave accelerated durability test (ADT); and
(d) a potential loss of less than about <30 mV at 0.8 A/cm² (over its lifetime).

20. The catalyst of claim 1, wherein the catalyst exhibits one or more of the following:
(a) minimum mass activity (MA) of about 1.18 A/mg_{PGM} as evaluated in a membrane electrode assembly (MEA) test;
(b) a rated power of about 13 W/mg_{PGM} as evaluated in a H₂/Air test;
(c) an end-of-life MA retention of about 70% after square wave accelerated durability test (ADT) as evaluated in a MEA test; and
(d) a potential loss of about 19 mV at 0.8 A/cm², as evaluated in a MEA test.

21. A method for preparing the catalyst of claim 1, comprising:
(a) providing a mixture comprising a carbon support, a platinum precursor, a non-platinum transition metal precursor, and a solvent;
(b) removing the solvent to provide a powder comprising the platinum precursor and the non-platinum transition metal precursor adsorbed on the carbon support; and
(c) annealing the powder to form platinum-based nanoparticles comprising a porous carbon overlayer.

22-30. (canceled)
